(19) United States
(12) Patent Application Publication
(10) Pub. No.: US 2014/0012862 A1
(43) Pub. Date: Jan. 9, 2014

(54) INFORMATION PROCESSING APPARATUS, INFORMATION PROCESSING METHOD, PROGRAM, AND INFORMATION PROCESSING SYSTEM

(71) Applicant: SONY CORPORATION, Tokyo (JP)

(72) Inventors: Yohei KAWAMOTO, Tokyo (JP); Taizo SHIRAI, Kanagawa (JP); Kazuya KAMIO, Tokyo (JP); Yu TANAKA, Tokyo (JP); Koichi SAKUMOTO, Tokyo (JP)

(21) Appl. No.: 13/903,217

(22) Filed: May 28, 2013

(30) Foreign Application Priority Data
Jul. 4, 2012 (JP) 2012150237

(51) Int. Cl. G06F 17/30

(52) U.S. Cl. CPC G06F 17/3053
USPC 707/750

(57) ABSTRACT

An information processing apparatus includes a calculation unit and a generation unit. The calculation unit is configured to calculate a frequency function which is a function relating to an appearance frequency of one or more attribute values of a database having a predetermined attribute and the one or more attribute values relating to the attribute. The generation unit is configured to generate sample data in accordance with the appearance frequency relating to the database on the basis of the frequency function calculated, the sample data including at least a part of the one or more attribute values as one or more sample attribute values.

### BACKGROUND

The present disclosure relates to an information processing apparatus, an information processing method, a program, and an information processing system used for providing a database, for example.

For example, Japanese Patent Application Laid-open No. 2010-93424 discloses a technique of obtaining only statistic values by a statistical method as a compiled result of pieces of data while concealing the individual pieces of data in a database. For example, in the case where customer information or the like owned by various organizations such as corporations is distributed for an academic research or a marketing analysis, the technique mentioned above is used.

In the data compiling method disclosed in Japanese Patent Application Laid-open No. 2010-93424, a transform operation by a function capable of defining an inverse function for the data is performed, and a disturbance process is performed for transformed data. On the basis of the disturbed data obtained by the disturbance process, an approximation value of the statistic value relating to the transformed data is calculated. Then, an inverse transform process is performed for the statistic value by the inverse function, thereby generating an approximation value of the statistic value relating to the data.

In the data compiling method, because not only the disturbance process but also the transform process is performed for the data, secrecy is increased. Meanwhile, in the transform process and the inverse transform process, accuracy of the statistic value is not lowered, so a reduction in accuracy of the statistic value is caused only in the disturbance process. As a result, it is possible to achieve the high accuracy of the statistic value to be generated and the data secrecy at the same time (see, for example, paragraphs 0001 to 0010 of Japanese Patent Application Laid-open No. 2010-93424).

### SUMMARY

In providing data as described above, for example, a useful system for a provider and a user of data is demanded.

In view of the above-mentioned circumstances, it is desirable to provide an information processing apparatus, an information processing method, a program, and an information processing system capable of attaining a data providing system useful for a data provider and a data user.

According to an embodiment of the present disclosure, there is provided an information processing apparatus including a calculation unit and a generation unit.

The calculation unit is configured to calculate a frequency function which is a function relating to an appearance frequency of one or more attribute values of a database having a predetermined attribute and the one or more attribute values relating to the attribute.

The generation unit is configured to generate sample data in accordance with the appearance frequency relating to the database on the basis of the frequency function calculated, the sample data including at least a part of the one or more attribute values as one or more sample attribute values.

In the information processing apparatus, the frequency function relating to the appearance frequency of the one or more attribute values held by the database is calculated. By using the frequency function, the sample data in accordance with the appearance frequency is generated. As a result, it is possible to attain the data providing system useful for the data provider and the data user.

The frequency function may express a first appearance frequency, which is an appearance frequency for each attribute value.

In this way, the function that expresses the first appearance frequency for each attribute value may be used as the frequency function.

The generation unit may generate the sample data so that the first appearance frequency for each sample attribute value expressed by the frequency function and a second appearance frequency, which is an appearance frequency for each sample attribute value in the sample data are corresponded to each other.

As a result, it is possible to generate useful sample data relating to the database.

The calculation unit may calculate a ratio of an appearance count of the one or more attribute values to a total count for each attribute value and calculate the frequency function that expresses an approximation value obtained by approximating the ratio of the appearance count as the first appearance frequency.

In the information processing apparatus, the ratio of the appearance count to the entire attribute values is calculated. Then, the approximation value of the ratio of the appearance count is expressed as the first appearance frequency. As a result, the sample data in accordance with the ratio of the appearance count is generated.

The calculation unit may select a predetermined model function and fit the predetermined model function to the ratio of the appearance count for each attribute value to calculate the frequency function.

In this way, by fitting the model function, the frequency function may be calculated.

The calculation unit may estimate a probability function in accordance with the ratio of the appearance count for each attribute value by a maximum likelihood estimation method to calculate the estimated probability function as the frequency function.

In this way, the probability function estimated by the maximum likelihood estimation method may be used as the frequency function.

The calculation unit may calculate a ratio of an appearance count of the one or more attribute values to a total count for each attribute value and generate the frequency function that expresses the ratio of the appearance count as the first appearance frequency.

In this way, the ratio of the appearance count may be expressed as the first appearance frequency. As a result, the sample data in accordance with the ratio of the appearance count is generated.

The information processing apparatus may further include a setting unit configured to set a predetermined attribute value out of the one or more attribute values as a non-target attribute value that is out of use for the calculation of the frequency function by the calculation unit. In this case, the calculation unit may calculate the frequency function relating to the appearance frequency of the one or more attribute values except the non-target attribute value set. Further, the generation unit may generate the sample data from the one or more attribute values except the non-target attribute value on the basis of the frequency function calculated.

In the information processing apparatus, the non-target attribute value, which is not used for the calculation of the frequency function, is set. For example, such a characteristic attribute value as to be intended to be excluded from the sample data is set as the non-target attribute value. As a result, useful sample data can be generated.

The calculation unit may calculate a ratio of an appearance count of the one or more attribute values to a total count for each attribute value and generate the frequency function on the basis of the ratio of the appearance count. In this case, the setting unit may set an attribute value whose ratio of the appearance count is smaller than a predetermined value as the non-target attribute value on the basis of the ratio of the appearance count for each attribute value.

In this way, the attribute value whose ratio of the appearance count is smaller than the predetermined value may be set as the non-target attribute value. As a result, for example, the characteristic value whose ratio of the appearance count is set as the non-target attribute value.

The calculation unit may calculate a ratio of an appearance count of the one or more attribute values to a total count for each attribute value and generate the frequency function on the basis of the ratio of the appearance count. In this case, the setting unit may set, as the non-target attribute value, an attribute value having a larger difference between the ratio of the appearance count and the first appearance frequency expressed by the frequency function than a predetermined value on the basis of the ratio of the appearance count for each attribute value. The calculation unit may calculate again the frequency function relating to the appearance frequency of the one or more attribute values except the non-target attribute value set. Further, the generation unit may generate the sample data from the one or more attribute values except the non-target attribute value on the basis of the frequency function calculated again.

In the information processing apparatus, the difference between the first appearance frequency expressed by the frequency function calculated and the ratio of the appearance count is calculated. The attribute value having the difference larger than the predetermined value is set as the non-target attribute value. The appearance frequency relating to the attribute value except the non-target attribute value is calculated again. As a result, the characteristic attribute value having the larger difference between the ratio of the appearance count and the first appearance frequency is set as the non-target attribute value.

The information processing apparatus may further include a reception unit and a selection unit.

The reception unit is configured to receive a request for the sample data relating to predetermined data in the database.

The selection unit is configured to select the predetermined data from the database on the basis of the request.

In this case, the calculation unit may calculate the frequency function in relation to the predetermined data selected. Further, the generation unit may generate the sample data from the predetermined data on the basis of the frequency function calculated.

In this way, the request for the sample data relating to the predetermined data in the database may be received. The predetermined data may be selected as appropriate, and the sample data relating to the data may be generated as appropriate.

The reception unit may receive external data held by an external apparatus and a request for the sample data relating to relevant data relevant to the external data in the database. In this case, the calculation unit may calculate the frequency function with a combination of the external data and the relevant data as the one or more attribute values. The generation unit may generate the sample data including the combination of the external data and the relevant data as the one or more sample attribute values on the basis of the frequency function calculated.

The information processing apparatus receives the external data and the request for the sample data from the external apparatus. The sample data for the combination of the external data and the relevant data relating thereto is generated. As a result, it is possible to attain the data providing system useful for the data provider and the data user.

The reception unit, the calculation unit, and the generation unit may be capable of being operated on the basis of a multi-party protocol.

The generation of the sample data for the combination of the external data and the relevant data described above may be executed on the basis of the multi-party protocol. As a result, it is possible to attain the data providing system useful for the data provider and the data user.

The reception unit may receive the external data encrypted by fully homomorphic encryption. In this case, the information processing apparatus may further include an encryption unit configured to encrypt the relevant data by the fully homomorphic encryption. Further, the calculation unit may calculate the frequency function in relation to a combination of the external data encrypted and the relevant data encrypted. The generation unit may generate, on the basis of the frequency function calculated, the sample data relating to the combination of the external data encrypted and the relevant data encrypted.

In this way, by the fully homomorphic encryption, the external data and the relevant data may be encrypted. The sample data relating to the combination of the encrypted external data and relevant data may be generated.

The calculation unit may be capable of generating, as functions relating to the appearance frequency of the one or more attribute values, a first frequency function and a second frequency function different from the first frequency function. In this case, the reception unit may receive a specification for selecting one of the first frequency function and the second frequency function from the external apparatus.

In this way, the calculation unit may generate the two different frequency functions. On the basis of the specification from the external apparatus, either one of the first and second frequency functions may be selected as appropriate. As a result, it is possible to attain the useful data providing system.

According to another embodiment of the present disclosure, there is provided an information processing method including calculating a frequency function which is a function relating to an appearance frequency of one or more attribute values of a database having a predetermined attribute and the one or more attribute values relating to the attribute.

Sample data in accordance with the appearance frequency relating to the database is generated on the basis of the frequency function calculated. The sample data includes at least a part of the one or more attribute values as one or more sample attribute values.

According to another embodiment of the present disclosure, there is provided a program causing a computer to execute the following steps.

A frequency function which is a function relating to an appearance frequency of one or more attribute values of a database having a predetermined attribute and the one or more attribute values relating to the attribute is calculated.

Sample data in accordance with the appearance frequency relating to the database is generated on the basis of the frequency function calculated. The sample data includes at least a part of the one or more attribute values as one or more sample attribute values.

According to another embodiment of the present disclosure, there is provided an information processing system including a first information processing apparatus and a second information processing apparatus.

The first information processing apparatus is capable of providing a database having a predetermined attribute and one or more attribute values relating to the attribute.

The second information processing apparatus is configured to transmit a request for sample data relating to the database to the first information processing apparatus.

The first information processing apparatus includes a reception unit, a calculation unit, and a generation unit.

The reception unit is configured to receive the request for the sample data from the second information processing apparatus.

The calculation unit is configured to calculate a frequency function, which is a function relating to an appearance frequency of the one or more attribute values of the database.

The generation unit is configured to generate the sample data in accordance with the appearance frequency relating to the database on the basis of the frequency function calculated, the sample data including at least a part of the one or more attribute values as one or more sample attribute values.

The second information processing apparatus includes a transmission unit and a reception unit.

The transmission unit is configured to transmit a request for the sample data.

The reception unit is configured to receive the sample data generated.

According to another embodiment of the present disclosure, there is provided an information processing apparatus including a transmission unit and a reception unit.

The transmission unit is configured to transmit a request for sample data relating to a database having a predetermined attribute and one or more attribute values relating to the attribute to a data providing apparatus capable of providing the database.

The reception unit is configured to receive the sample data in accordance with an appearance frequency of the one or more attribute values, the sample data being generated on the basis of a frequency function as a function relating to the appearance frequency by the data providing apparatus that receives the request and including at least a part of the one or more attribute values as one or more sample attribute values.

As described above, according to the embodiments of the present disclosure, it is possible to attain the data providing system useful for the data provider and the data user.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structural example of a data providing system according to a first embodiment of the present disclosure;

FIG. 2 is a diagram showing an example of a hardware structure of a data providing apparatus and a data reception apparatus;

FIG. 3 is a schematic diagram for explaining the outline of an operation of the data providing system;

FIG. 4 is a diagram showing an example of a database held by the data providing apparatus;

FIG. 5 is a schematic diagram showing a software structural example of the data providing apparatus;

FIG. 6 is a flowchart showing generation of pseudo sample data by the data providing apparatus;

FIGS. 7A, 7B, and 7C are diagrams each showing an example of predetermined data selected from the database;

FIG. 8 is a schematic diagram showing ratios of appearance counts for each attribute value;

FIG. 9 is a diagram for explaining an example of a frequency function that approximates a frequency distribution;

FIG. 10 is a diagram for explaining the frequency function with the ratio of the appearance count for each attribute value as a first appearance frequency;

FIGS. 11A and 11B are schematic diagrams for explaining a setting process for a non-target attribute value according to a second embodiment of the present disclosure;

FIG. 12 is a schematic diagram for explaining another example of the setting process for the non-target attribute value;

FIG. 13 is a schematic diagram for explaining another example of the setting process for the non-target attribute value;

FIG. 14 is a schematic diagram for explaining the outline of an operation of a data providing system according to a third embodiment of the present disclosure;

FIGS. 15A and 15B are diagrams showing an example of databases held by a data providing apparatus and a data reception apparatus;

FIG. 16 is a schematic diagram showing an example of a software structure of the data providing apparatus;

FIG. 17 is a flowchart showing generation of pseudo sample data by the data providing apparatus;

FIGS. 18A and 18B are diagrams each showing a table that shows data relating to a predetermined condition;

FIG. 19 is a schematic diagram for explaining the outline of an operation of a data providing system according to a fourth embodiment of the present disclosure;

FIG. 20 is a schematic diagram showing an example of a software structure of the data providing apparatus;

FIG. 21 is a flowchart showing generation of pseudo sample data by the data providing apparatus;

FIG. 22 is a schematic diagram showing an example of a software structure of a data providing apparatus according to a fifth embodiment of the present disclosure; and

FIG. 23 is a flowchart showing generation of pseudo sample data by the data providing apparatus.

### DETAILED DESCRIPTION OF EMBODIMENTS

Hereinafter, an embodiment of the present disclosure will be described with reference to the drawings.

### First Embodiment

### Structure of Information Processing System

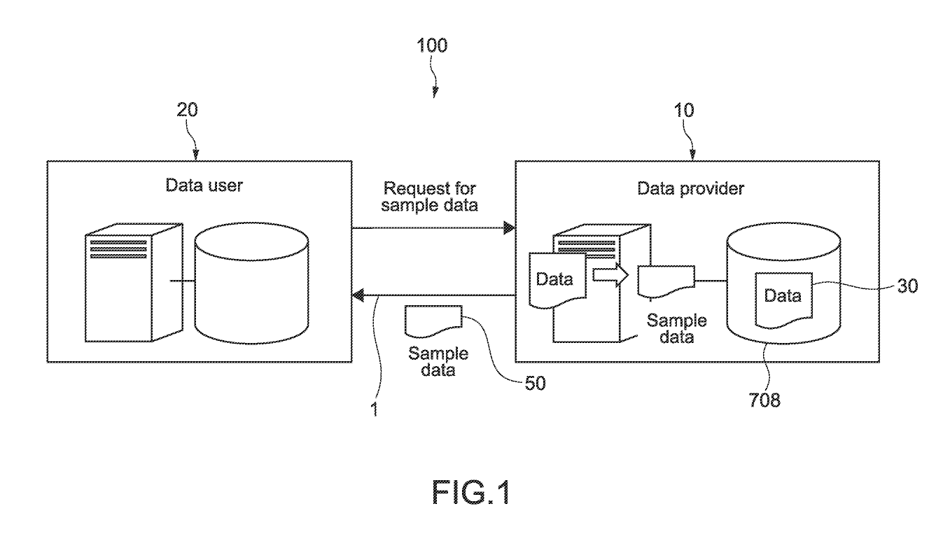

FIG. 1 is a diagram showing a structural example of a data providing system, which is an information processing system according to a first embodiment of the present disclosure. A data providing system 100 includes a data providing apparatus 10 and a data reception apparatus 20. The data providing apparatus 10 is a first information processing apparatus used by a data provider. The data reception apparatus 20 is a second information processing apparatus used by a data user.

The data providing apparatus 10 and the data reception apparatus 20 are connected to each other by a network 1 such as a LAN (local area network) and a WAN (wide area network). The connection form of the data providing apparatus 10 and the data reception apparatus 20 is not limited as long as the two apparatuses 10 and 20 are capable of transmitting and receiving data to and from each other.

In the data providing system 100, a plurality of data providing apparatuses 10 and a plurality of data reception apparatuses 20 may be provided. In other words, the number of data providing apparatuses 10 and the number of data reception apparatuses 20 are not limited. In the data providing system 100, other apparatuses connected to each other via the network 1 correspond to external apparatuses. For example, in FIG. 1, the data reception apparatus 20 corresponds to the external apparatus for the data providing apparatus 10.

As shown in FIG. 1, the data providing apparatus 10 includes a storage unit 709 that stores various pieces of data. In the storage unit 708, a database 30 capable of providing data to the external apparatus via the network 1 is stored. The database 30 is stored in the storage unit 708 held by the data providing apparatus 10.

For example, the data user requests provision of data in the case where the database 30 held by the data providing apparatus 10 is desired data. The data provider transmits a request for a sample data 50 relating to the database 30 to the data providing apparatus 10 by using the data reception apparatus 20 in order to confirm whether the database 30 is the desired data or not.

Upon reception of the request for the sample data 50, the data providing apparatus 10 generates the sample data 50 according to the present technology as will be described below. Then, the data providing apparatus 10 transmits the sample data 50 to the data reception apparatus 20. By generating the sample data 50 according to the present technology, the data providing system 100 useful for the data provider and the data user is attained.

(Hardware Structure of Data Providing Apparatus)

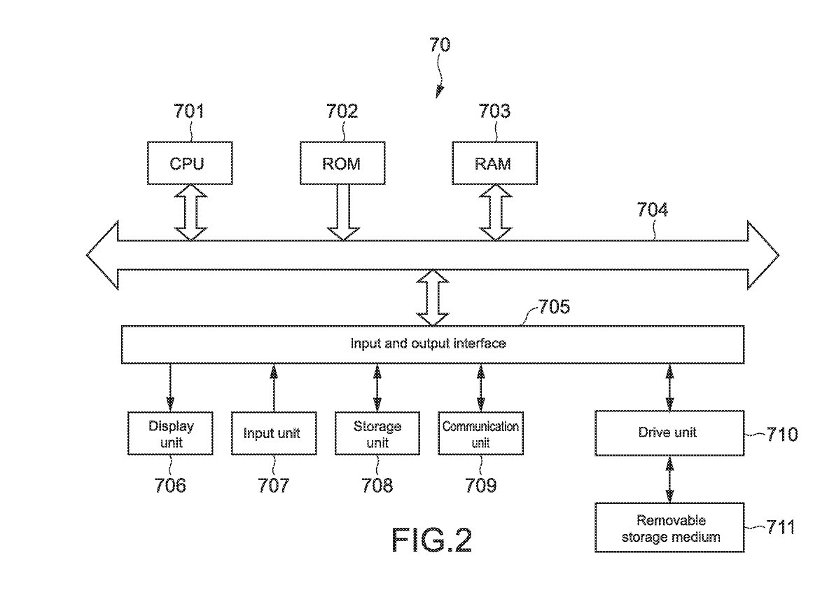

In this embodiment, as the data providing apparatus 10 and the data reception apparatus 20, a PC (personal computer) 70 having a hardware structure shown in FIG. 2 is used but is not limited thereto. A computer having another structure may be used as appropriate. Further, the data providing apparatus 10 and the data reception apparatus 20 do not have to have the same hardware structure.

The PC 70 includes a CPU (central processing unit) 701, a ROM (read only memory) 702, a RAM (random access memory) 703, an input and output interface 705, and a bus 704 that connects those to each other.

To the input and output interface 705, a display unit 706, an input unit 707, a storage unit 708, a communication unit 709, a drive unit 710, and the like are connected.

The display unit 706 is a display device that uses liquid crystal, EL (electro-luminescence), a CRT (cathode ray tube), or the like.

The input unit 707 is, for example, a pointing device, a keyboard, a touch panel, or another operation device. In the case where the input unit 707 includes the touch panel, the touch panel can be integral with the display unit 706.

The storage unit 708 is a non-volatile storage device such as an HDD (hard disk drive), a flash memory, or another solid-state memory.

The drive unit 710 is a device capable of driving a removable recording medium 711 such as an optical recording medium, a floppy (registered trademark) disk, a magnetic recording tape, and a flash memory. In contrast, the storage unit 708 is often used as a device which mainly drives a non-removable recording medium and is mounted on the data providing apparatus 10 in advance.

In the removable recording medium 711, the database 30 may be stored. By the drive unit 710, the database 30 may be read as appropriate.

The communication unit 709 is a communication apparatus, such as a modem and a router, for communicating with another device which is connectable to the LAN, the WAN, or the like. The communication unit 709 may perform wired or wireless communication. The communication unit 709 may be used separately from the PC 70.

For example, the communication unit 709 receives various pieces of data, instructions, requests or the like from the data reception apparatus 20. For example, the request for the sample data 50 described above is received by the communication unit 709. In this embodiment, the communication unit 709 functions as a reception unit of the data providing apparatus 10.

Further, when the structure shown in FIG. 2 is the hardware structure of the data reception apparatus 20, the communication unit 709 transmits various pieces of data, requests, or the like to the data providing apparatus 10. Further, the communication unit 709 receives the sample data 50 or the like from the data providing apparatus 10. Therefore, the communication unit 709 functions as a transmission unit and a reception unit of the data reception apparatus 20 in this embodiment.

The information processing by the PC 70 having the hardware structure described above is implemented by software stored in the storage unit 708, the ROM 702, or the like and a hardware resource of the PC 70 in cooperation with each other. Specifically, the CPU 701 loads a program that forms the software stored in the storage unit, the ROM 702, or the like, into the RAM 703 and executes the program, thereby implementing the information processing. The program is installed in the PC 70 through a recording medium or the like. Alternatively, the program may be installed in the PC 70 via a global network or the like.

(Operation of Data Providing System)

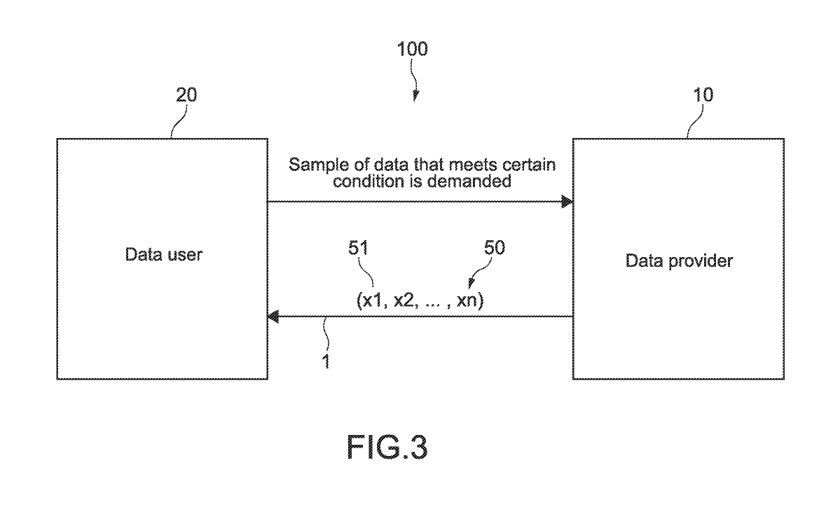

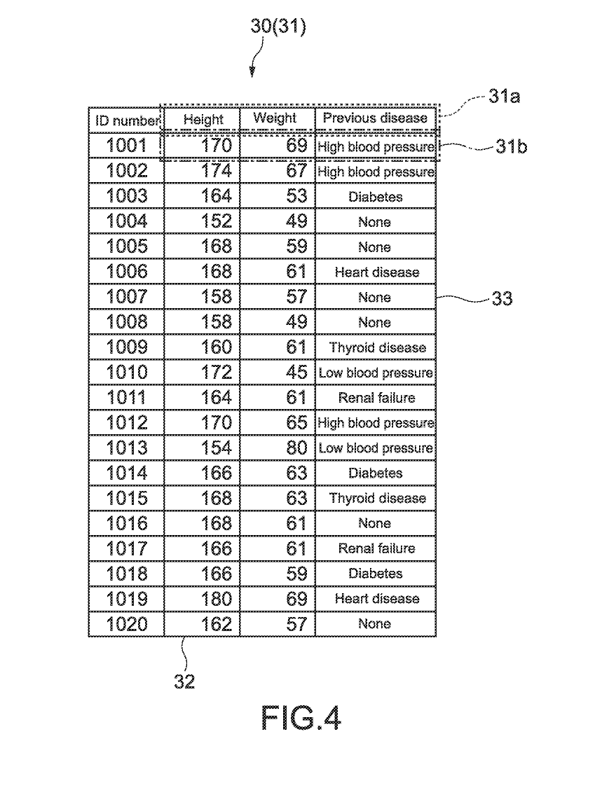

FIG. 3 is a schematic diagram for explaining the outline of an operation of the data providing system 100 according to this embodiment. FIG. 4 is a diagram showing an example of the database 30 held by the data providing apparatus 10 according to this embodiment.

The database 30 held by the data providing apparatus 10 of this embodiment is a relational database and is shown by a table 31 shown in FIG. 4. The table 31 has four fields (columns) 32 including an “ID number”, a “height”, a “weight”, and a “previous disease” as field names. The table 31 further has records (rows) 33 in each of which data of the field is stored.

Out of the four fields, the field 32 of the “ID number” is set as a main key. Therefore, the record 33 is identified by the “ID number”, and the “height”, the “weight”, and the “previous disease” associated with each other are stored in the record 33. In the four fields 32 of the “ID number”, the “height”, the “weight”, and the “previous disease”, pieces of data corresponding to predetermined domains are stored. In the fields 32 of the “ID number”, the “height”, and the “weight”, integers are put, and in the field 32 of the “previous disease”, a character string is put.

The database 30 has a predetermined attribute and one or more attribute values relating to the attribute. In this embodiment, a combination of the fields 32 of the “height”, the “weight”, and the “previous disease” held by the table 31 corresponds to a predetermined attribute 31a. A combination of pieces of data of the “height”, the “weight”, and the “previous disease” corresponds to one or more attribute values 31b. That is, in this embodiment, the fields 32 in the table 31 that indicates the relational database which are not the main key correspond to the attribute, and the pieces of data of the attributes stored in the records 33 correspond to the attribute values 31b.

As shown in FIG. 3, from the data reception apparatus 20, a request for the sample data 50 which meets certain conditions is transmitted. The certain conditions are as follows.

Condition 1: data of heights in the table 31

Condition 2: data of combinations of heights and weights of IDs whose heights are 170 cm or more

Condition 3: data of previous diseases of persons who have previous diseases

That is, in this embodiment, the data reception apparatus 20 transmits, to the data providing apparatus 10, the request for the sample data 50 relating to the predetermined pieces of data (data that meets the conditions mentioned above or the like) in the database 30.

The data providing apparatus 10 that receives the request for the sample data 50 generates the sample data 50 according to the present technology and transmits the data to the data reception apparatus 20. The sample data 50 includes at least a part of the one or more attribute values 31b in the database 30 as one or more sample attribute values 51. Elements of sample data (x1, x2, . . . , xn) shown in FIG. 3 represent the sample attribute values 51.

(Operation of Data Providing Apparatus)

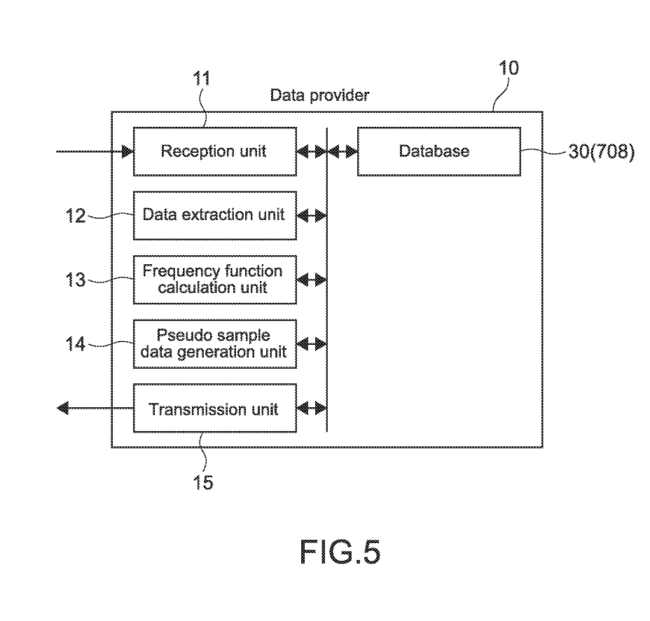

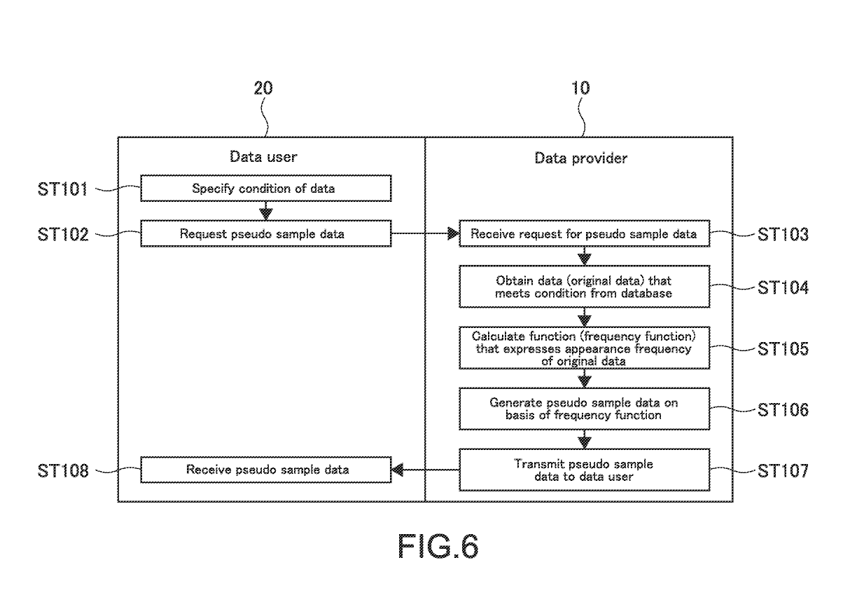

To generate the sample data 50 by the data providing apparatus 10 according to this embodiment will be described in detail. FIG. 5 is a schematic diagram showing a software structural example of the data providing apparatus 10. FIG. 6 is a flowchart showing the generation of the sample data 50 by the data providing apparatus 10.

For example, the CPU 701 that executes a predetermined program implements software blocks shown in FIG. 5. The units shown in the blocks operate as shown in the flowchart of FIG. 6, thereby generating the sample data 50. It should be noted that dedicated hardware for implementing the blocks may be used as appropriate.

The data user specifies a condition of data necessary as the sample data 50 for the data reception apparatus 20 (Step 101). The transmission unit of the data reception apparatus 20 transmits the request for the sample data 50 of data that meets the condition specified to the data providing apparatus 10 (Step 102). It should be noted that the sample data 50 according to the present technology may be referred to as a pseudo sample data 50.

A reception unit 11 of the data providing apparatus 10 shown in FIG. 5 receives the request for the pseudo sample data 50 (Step 103). On the basis of the request for the pseudo sample data 50, a data extraction unit 12 extracts data that meets the condition from the database 30. As a result, the predetermined data is selected and obtained from the database 30 (Step 104). In this embodiment, the data extraction unit 12 functions as a selection unit.

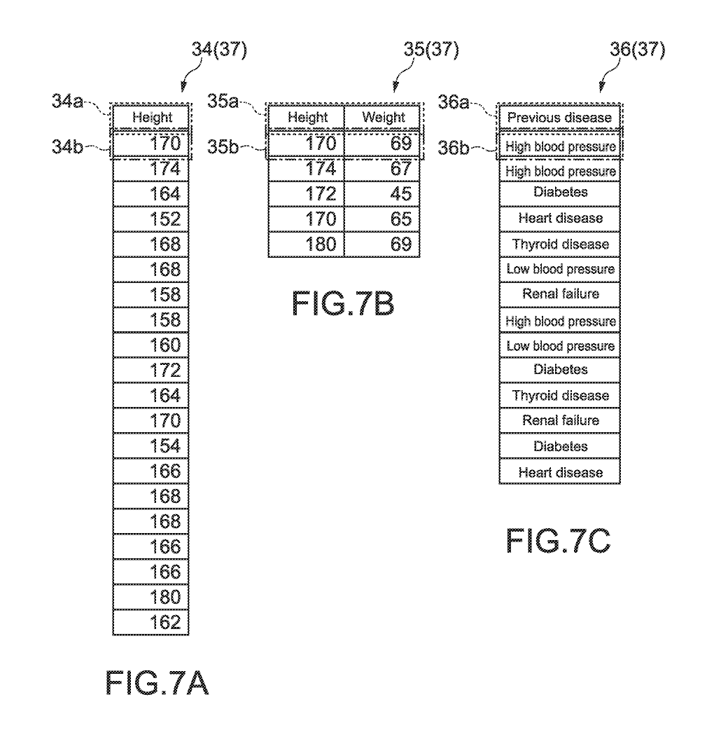

FIGS. 7A to 7C are diagrams each showing an example of the predetermined data selected from the database 30. For example, in the case where Condition 1 mentioned above is specified, the data extraction unit 12 extracts a table 34, which includes data of heights shown in FIG. 7A. In the table 34, the “height” is a predetermined attribute 34a, and data of a value thereof is one or more attribute values 34b.

In the case where Condition 2 is specified, the data extraction unit 12 extracts a table 35, which is combination data of heights and weights of IDs whose heights are 170 cm or more shown in FIG. 7B. In the table 35, a combination of the “height” and the “weight” is a predetermined attribute 35a, and values thereof are one or more attribute values 35b.

In the case where Condition 3 is specified, the data extraction unit 12 extracts a table 36, which is data of previous diseases of persons who have the previous diseases shown in FIG. 7C. In the table 36, the “previous disease” is a predetermined attribute 36a, and character strings thereof are one or more attribute values 36b.

In the following description, the predetermined data extracted by the data extraction unit 12 may be referred to as an original data 37. Here, as the original data 37, the table 34 of the data of the heights shown in FIG. 7A is given as an example.

A frequency function calculation unit 13 calculates a frequency function, which is a function for expressing an appearance frequency of the original data 37 (Step 105). Here, the frequency function is a function relating to the appearance frequency of the one or more attribute values held by the database. That is, the frequency function relates to how often a certain attribute value appears in the database. In this embodiment, a function that expresses a first appearance frequency, which is the appearance frequency for each attribute value, is calculated as the frequency function. Therefore, the frequency function is a function that inputs the attribute values and outputs the first appearance frequency.

In Step 105 of FIG. 6, the frequency function relating to the appearance frequency of the one or more attribute values 34b held by the table 34 is calculated. Therefore, the data of the heights as the attribute values 34b is input, and the frequency function that outputs the first appearance frequency for each attribute value 34b is calculated.

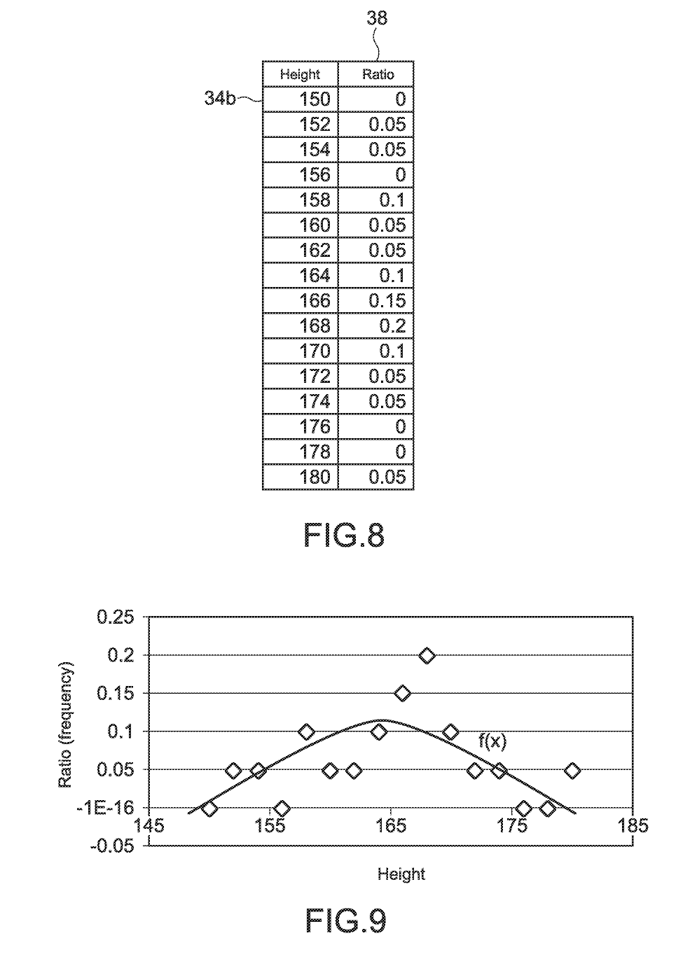

In the following, the calculation of the frequency function by the frequency function calculation unit 13 will be described. FIGS. 8 to 10 are diagrams for explaining the calculation of the frequency function. In this embodiment, the frequency function calculation unit 13 calculates a ratio of the number of appearances (appearance count) of the one or more attribute values 34b to the total count for each attribute value 34b.

FIG. 8 is a diagram showing data of ratios 38 of the appearance counts for each attribute value 34b regarding the table 34 of data of the heights shown in FIG. 7A. For each attribute value 34b (for each integer that expresses the height), the number of appearances in the table 31 of the attribute values 34b is calculated. A ratio obtained by dividing the appearance count for each attribute value 34b by the total counts of the attribute values 34b in the table 31 is calculated as the ratio 38 of the appearance count for each attribute value 34b.

As shown in FIG. 8, in this embodiment, the ratios 38 of the appearance counts from a value of 150, which is smaller than 152 as the smallest attribute value 34b in the table 34 shown in FIG. 7A, to a value of 180, which is the largest attribute value 34b in the table 31, are calculated as data. A selection method for the attribute values 34b for calculating the ratios 38 of the appearance counts is not limited. For the attribute value 34b which is not included in the original data 37, the ratio of the appearance count (value of 0 is obtained in this case) may be calculated. The attribute value 34b may be selected as appropriate in accordance with the calculation of the frequency function.

In this embodiment, a frequency function that expresses an approximation value obtained by approximating the ratio 38 of the appearance count for each attribute value 34b shown in FIG. 8 as a first appearance frequency is calculated. That is, such a frequency function as to approximate a frequency distribution of the attribute values in the original data 37 is calculated.

FIG. 9 is a diagram for explaining an example of the frequency function that approximates the frequency distribution. As shown in FIG. 9, the ratios 38 of the appearance frequencies for each attribute value 34b are plotted with the transverse axis being as the height and the vertical axis being as the ratio of the appearance frequency. A frequency function f(x) that approximates the frequency distributions of the attribute values is calculated.

To calculate the frequency function, in this embodiment, the frequency function calculation unit 13 selects a predetermined model function, and the predetermined model function is subjected to fitting to the ratios 38 of the appearance counts for each attribute value 34. As a result, the frequency function is calculated. The model function is a function that is to be a model of the frequency function that outputs the first appearance frequency of each of the attribute values 34b to the attribute values 34b. The selection method for the model function and the fitting method for the ratios 38 of the appearance counts are not limited, and various techniques including known techniques may be used.

Examples of the model function selected include an exponential function, a linear function, a logarithmetic function, a polynomial function, a gauss function, and the like. In this embodiment, the following gauss function is selected as the model function.

g(x)=a+b·exp(−(x−c)²/d²)

where a variable x expresses a value of the height, and an output g(x) expresses the first appearance frequency.

As the fitting method, typically, a least squares method is used, but another method may be used. For example, in the case where the gauss function mentioned above is subjected to the fitting by the least squares method, the parameters are determined to be a=−0.075, b=0.185, c=165.8, and d=16.1, respectively.

In this embodiment, the model function g(x) that has been subjected to the fitting is normalized, thereby calculating the frequency function f(x). Specifically, if the one or more attribute values 34b shown in FIG. 8 are represented by (y1 to ym), a normalized parameter k is determined so that kΣg(yi)=1 is obtained. For example, if m=15 and yi=152+2(i−1) are set, k=0.98 is obtained. As a result, as the frequency function f(x) for generating the pseudo sample data 50, k·g(x) is obtained (f(x)=k·g(x)).

By the frequency function f(x)=k·g(x), the approximation value obtained by approximating the ratios 38 of the appearance counts for each attribute value 34b is output as the first appearance frequency. It should be noted that in the case where the function calculated obtains a value less than 0, the attribute values 34b used as the pseudo sample data 50, that is, the attribute values 34b selected as the sample attribute values 51 may be limited to a range that does not include 0.

If Condition 2 mentioned above is specified in Step 101 shown in FIG. 6, the data extraction unit 12 extracts the table 35 shown in FIG. 7B. In this case, ratios of appearance counts for each attribute value 35b are calculated with a combination of pieces of data of the “height” and the “weight” as the attribute vale 35b. Then, a frequency function that outputs an approximation value of the ratio of the appearance count as the first appearance frequency is calculated.

A basic way of obtaining the frequency function in this case is the same as above. The model function selected has one variable in the above, but in this case, two variables. The model function having two variables is selected, and the model function is subjected to the fitting to the ratios of the appearance counts for each attribute value 35b, thereby making it possible to calculate the frequency function relating to the table 35. In the case where a table as a target for calculating the frequency function has a larger number of fields, a model function having a plurality of variables may be selected as appropriate.

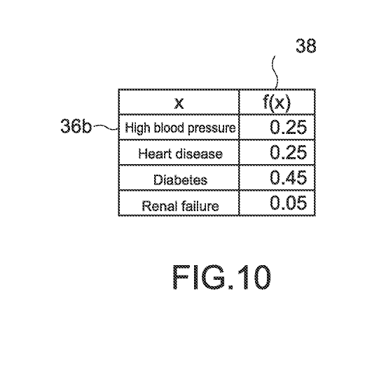

If Condition 3 mentioned above is specified in Step 101 shown in FIG. 6, the data extraction unit 12 extracts the table 36 shown in FIG. 7C. In this case, the ratios 38 of the appearance counts for each attribute value 36b is calculated with the data of “previous disease” as the attribute value 36b as shown in FIG. 10.

Regarding Conditions 1 and 2, the attribute values are continuous values having the order. On the other hand, in the table 36 relating to Condition 3, the attribute values 36b are character strings that indicate the names of the previous diseases, which do not have the order. That is, in the table 36, as the attribute values 36b, discrete values are stored. In this case, as shown in FIG. 10, a function that outputs the ratios 38 of the appearance counts for each attribute value may be calculated as the frequency function f(x) with the attribute values 36b as the variables x.

In this way, the frequency function that indicates the ratio 38 of the appearance frequency as the first appearance frequency may be calculated. The frequency function can be calculated in the case where the attribute value is formed of a plurality of fields, that is, the case where a plurality of variables are provided, the case where the attribute values are values having the order, or the case where a combination thereof is provided.

Another example of the method of generating the frequency function will be described. As will be described below, by estimating a probability function in accordance with the appearance counts for each attribute value by a maximum likelihood estimation method, the probability function estimated may be calculated as the frequency function.

For example, a probability model is postulated, and a parameter is obtained by the maximum likelihood estimation method (maximum likelihood method), thereby estimating a frequency function. The maximum likelihood estimation method refers to a method used for estimating, from given data, a parameter of a probability distribution which is followed by the data, and can be applied to various models such as a gauss distribution, a binominal distribution, and a Poisson distribution.

A specific example will be given. First, a probability density function which is followed by the variable x or a probability function p (x; θ) is selected. A parameter θ is estimated on the basis of the one or more attribute values (y1 to ym), which are the data of the attribute values.

As the probability model, a normal linear model is considered. It is thought that the data follows yi=μ+εi (i=1·r). μ is a fixed value (for example, an average value), and εi is an error that follows the gauss distribution and is independent among data. In this example, a problem of estimating the parameter θ is a problem of estimating a dispersion σ′ of μ and εi.

For the estimation of the parameter θ by the maximum likelihood estimation method, θ′ that maximizes a log likelihood function log·p(x; θ) of a likelihood function p(x; θ)=πp (xi; θ) is a maximum likelihood amount. For example, the maximum likelihood amount in the normal linear model described above is μ′=(1/r)Σxi, ν²=(1/r)Σ(xi−μ′)². In the case where the data of the attribute values is as in the diagram shown in FIG. 8, μ′=165.4 and σ²=43.24 are obtained.

In this way, the probability function estimated by the maximum likelihood estimation method may be calculated as the frequency function. It should be noted that the estimation method of the probability function by the maximum estimation method is not limited. A probability model selected is arbitrary.

On the basis of the frequency function calculated, a pseudo sample data generation unit 14 generates the pseudo sample data 50 in accordance with the appearance frequency relating to the database (original data 37) including at least a part of the one or more attribute values 34b as the one or more sample attribute values 51 (Step 106).

In this embodiment, the pseudo sample data 50 is generated so that the first appearance frequency for each sample attribute value 51 expressed by the frequency function f(x) and a second appearance frequency, which is an appearance frequency for each sample attribute value 51 in the pseudo sample data 50 are corresponded to each other. For example, on the basis of the frequency function f(x), the data is output so that the appearance probability in the pseudo sample data 50 of a sample attribute value x is a value of f(x), thereby generating the pseudo sample data (x1, x2, . . . , and xn).

When the sample attribute value xn is input in the frequency function f(xn), an output thereof is the first appearance frequency of the sample attribute value xn. On the other hand, the appearance frequency of xn in the pseudo sample data (x1, x2, . . . , xn) is set as the second appearance frequency. Typically, the ratio of the appearance count of the sample attribute value 51 to the total count in the pseudo sample data 50 is the second appearance frequency. It should be noted that the approximation value of the ratios of the appearance counts for each sample attribute value 51 may be set as the second appearance frequency.

The pseudo sample data 50 is generated so that the first and second appearance frequencies are corresponded to each other. Typically, the pseudo sample data 50 is generated so that the first and second appearance frequencies are equal to each other, but is not limited to this. The first and second appearance frequencies may be associated with each other by the approximation. The sample attribute value 51 may be output with such an appearance distribution as to correspond to the appearance distribution of the attribute values in the original data 37, and the pseudo sample data 50 may be generated. As a result, it is possible to generate the pseudo sample data 50 with the characteristic of the original data remained.

It should be noted that the number of sample attribute values 51 included in the pseudo sample data 50 is not limited. The number thereof may be set as appropriate in consideration of the number of attribute values of the original data 37, prevention of leakage of data, or the like. Further, the number thereof may be set as appropriate on the basis of various conditions such as a request from a data user relating to accuracy of the pseudo sample data 50 and a setting as a data providing service.

The pseudo sample data 50 generated is transmitted to the data reception apparatus 20 by a transmission unit 15 (Step 107). Then, the reception unit of the data reception apparatus 20 receives the pseudo sample data 50 (Step 108).

As described above, in the data providing apparatus 10 as the information processing apparatus according to this embodiment, the frequency function relating to the appearance frequencies of the one or more attribute values held by the database 30 (or original data 37) is calculated. The frequency function is used to generate the pseudo sample data 50 in accordance with the appearance frequency. As a result, it is possible to achieve the data providing system useful for the data provider and the data user.

As the frequency function, a function that expresses the approximation value of the ratio of the appearance count for each attribute value as the first appearance frequency or a function that expresses the ratio of the appearance count for each attribute value as the first appearance frequency is calculated. As a result, the pseudo sample data 50 in accordance with the ratio of the appearance count is generated.

As the method for generating the sample data relating to the database, the following method is conceivable. For example, a method in which the data providing apparatus selects data of a certain ratio in the database at random and generates a part of the data selected is conceivable. In this method, in the case where the amount of data in the database is small, the number of pieces of sample data is also small, and therefore it is difficult to determine whether it is a desired database or not by the data user. That is, the usefulness thereof is lowered as the sample data to be provided to the data provider.

A method of generating data obtained by adding a noise to the data in the database as sample data is also conceivable. For example, for the original data (d1, d2, . . . , dn), data that is (d1+ε1, d2+ε2, . . . , dn+εn) is generated as the sample data. ε1 to en are noises that follow a uniform distribution having an average value of 0, the gauss distribution, for example.

In this method, adding the noise to the values having order is meaningful, but adding the noise to values having no order (such as previous diseases and places of residence) is not meaningful, and only data deformed by such a simple model as to add a noise as sample data is obtained, which provides a low usefulness as the sample data.

A method in which data obtained by substituting elements (attribute values and the like) in the database with a certain probability is generated as the sample data. For example, for the original data (d1, d2, . . . , dn), (d′1, d′2, . . . , d′n) are generated by substitution. As the method of the substitution, a method is conceivable in which when elements in the database are (a1 to ak), a probability of substituting ak by ak, that is, a probability of performing no substitution is set as ρ, and a probability of substituting ak by an element other than ak is set to (1−ρ)/(n−1).

In this method, the frequency distribution of the entire original data is changed, and it may be impossible for the data provider to grasp a tendency of the database. Further, only the data deformed by such a simple model as to substitute the element as the sample data is obtained, and the usefulness as the sample data is low.

In addition, some statistics such as an average and a dispersion of the database are calculated, and the values thereof are generated as characteristic amounts that represent the characteristics of the data. A method is conceivable in which the characteristic amounts are transmitted as the sample data to the data user. In the method, it may be impossible for the data user to confirm limited characteristic amounts, and therefore the usefulness of the sample data is low. Alternatively, the case is also conceivable in which the characteristic amounts such as the average and the dispersion are information that is demanded by the data user. In this case, the sample data itself is the data demanded by the user, and a providing service of the database is not established. Further, it may be impossible to prevent the leakage of the database.

In contrast, in the method of generating the pseudo sample data 50 according to this embodiment, the frequency function relating to the appearance frequency is calculated. Then, the pseudo sample data 50 is generated so that the first and second appearance frequencies are corresponded to each other. By generating the pseudo sample data 50 in this way, it is possible to transmit the information relating to the data as the pseudo sample data 50 while preventing the leakage of the data.

For example, in the case where the sample data of a certain ratio is generated, the assumption is made that the sample ratio is 10%, and the number of total pieces of data is 100. In this case, it is necessary for the data user to find out the characteristic of the entire data from 10 pieces of data. In contrast, in this embodiment, the frequency function is generated on the basis of the whole of the 100 pieces of data, which is a 10-times increase in number. As a result, the data on which the tendency of the entire data is reflected can be generated as the pseudo sample data 50. As the number of total pieces of data is increased, the estimation or the like of the frequency function can be performed with higher accuracy, so the generation method according to this embodiment is the method in which the original data structure is further reflected. For example, if the sample ratio is set to p %, in the pseudo sample data 50 according to this embodiment, information which is equivalent to approximately 100/p-times data can be provided to the data user.

Further, in this embodiment, even in the case of the data of the values having no order (previous diseases, places of residence, or the like), the pseudo sample data 50 can be provided. The method in which the noise is added as described above is not meaningful in the case where the values have no order. In this embodiment, an attention is focused on the frequency of the attribute value, so it is possible to calculate the frequency function irrespective of the order of the values. On the basis of the frequency function, the pseudo sample data 50 can be generated.

Because it is possible to provide the pseudo sample data 50 with the original data structure remained, it is possible to limit the leakage of information more than needs while giving information to such an extent that the data user can perform determination for the use of the data. For example, in the method in which the elements of the database are substituted, the probability distribution of the data is changed. On the other hand, in this embodiment, various functions or approximation method (fitting, maximum likelihood method, or the like) can be selected as the frequency function that approximates the frequency distribution of the attribute values. As a result, by appropriately selecting a function in accordance with the original data structure, it is possible to cause the original data structure to remain. Further, it is possible to adjust the degree of approximation by the selection or the like of the function, so it is possible to limit the leakage of information more than needs.

Further, in this embodiment, by limiting the number of sample attribute values 51 included in the pseudo sample data 50, it is possible to adjust the information amount to be given to the data user. For example, the assumption is made that the frequency distribution is approximated by a polynomial function of f(x)=a0+a1x+ . . . +aqxⁿ. In this case, as described in another method above, (a0, a1, . . . , aq) are used as the sample data as the data characteristic amount. As a result, in the case where the data is demanded by the data user, the data leaks by the sample data. In this embodiment, on the basis of f(x) calculated, the pseudo sample data (x1, x2, . . . , xn) is generated, so such a problem does not occur.

Similarly, the gauss distribution is subjected to the maximum likelihood estimation, thereby calculating the following frequency function f(x).

f(x)=(1/√(2π)σ)exp(−(x−μ)²/2σ²))

In this case, if (μ, σ) is used as the data characteristic amount, there is a fear that the information may leak. In this embodiment, the pseudo sample data (x1, x2, . . . , xn) is generated on the basis of f(x), so the problem does not occur.

On the basis of the pseudo sample data (x1, x2, . . . , xn) according to this embodiment, the data user may calculate (a0, a1, . . . , aq) or (μ, σ) as the data characteristic amount. In this case, to generate the data characteristic amount with high accuracy, a large number of pieces of data are necessary. By adjusting the number of sample attribute values 51 of the pseudo sample data 50, it is possible to adjust the amount of information to be given to the data user. As a result, it is possible to prevent unnecessary leakage of the information.

On the other hand, on the basis of the pseudo sample data 50 according to this embodiment, the data user can obtain various statistics within a certain degree of accuracy range. That is, as compared to the case where an average or dispersion is transmitted as the data characteristic amount, it is possible to grasp an entire tendency and obtain other statistics than the average and the dispersion within some degree of accuracy range. This can be performed freely by the data user.

### Second Embodiment

A data providing system according to a second embodiment of the present disclosure will be described. In the following description, explanation of the same structure and operation as the data providing system 100 according to the first embodiment will be omitted or simplified.

In this embodiment, the following process is performed for a calculation process of a frequency function by the frequency function calculation unit. In this embodiment, the frequency function calculation unit sets a predetermined attribute value, out of one or more attribute values, as a non-target attribute value which is not used for the calculation of the frequency function. In this embodiment, the frequency function calculation unit also operates as a setting unit, and the frequency function calculation unit sets the non-target attribute value. However, a block for setting the non-target attribute value may be provided additionally to the frequency function calculation unit.

The frequency function calculation unit calculates a frequency function relating to an appearance frequency of one or more attribute values excluding the non-target attribute value set. The pseudo sample data generation unit generates pseudo sample data from one or more attribute values excluding the non-target attribute value on the basis of the frequency function calculated.

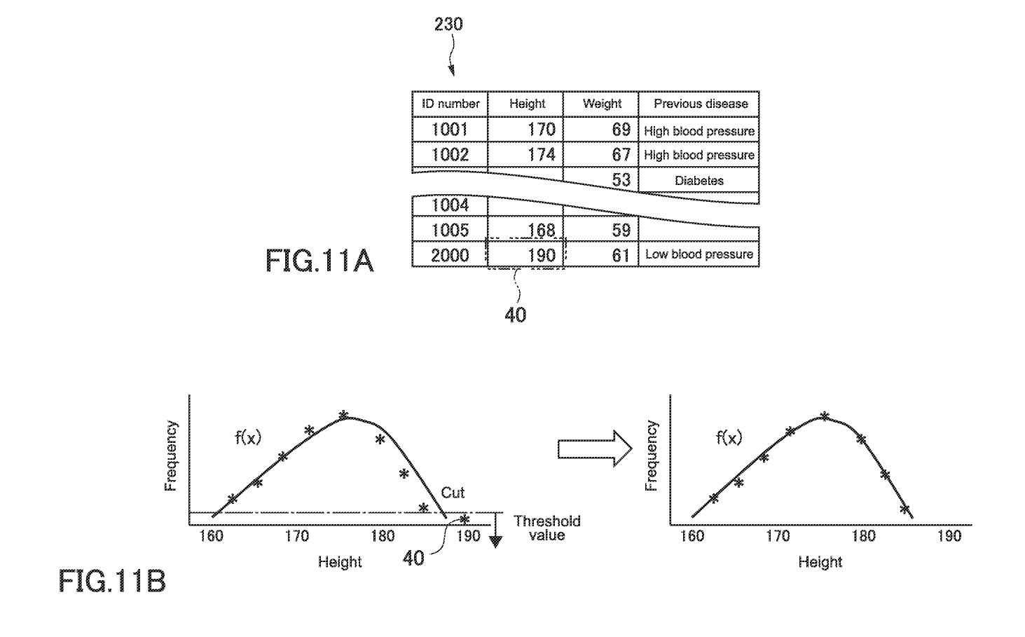

FIGS. 11 to 13 are schematic diagrams for explaining a setting process of the non-target attribute value. For example, the assumption is made that, for data relating to heights in a table 230 as shown in FIG. 11A, pseudo sample data is generated, and at this time, appearance frequencies for each attribute value (height) is subjected to fitting to a model function, thereby calculating the frequency function.

In this embodiment, when the frequency function is calculated, an attribute value the frequency of which is smaller than a predetermined value is set as a non-target attribute value 40. In the table 230 of FIG. 11A, as an attribute value of a height in a record of ID 2000, “190” is stored. As shown in FIG. 11B, the attribute value of 190 is smaller than a threshold value relating to a preset appearance frequency. Therefore, the attribute value of the height of 190 cm is set as the non-target attribute value 40.

It should be noted that the frequencies for each attribute value indicated on the vertical axis of FIG. 11B are typically the ratios of the appearance counts for each attribute value as described in the first embodiment. That is, in the case where the ratios of the appearance counts for each attribute value are calculated, and the frequency function is generated on the basis of the ratios of the appearance counts, the attribute value of the ratio of the appearance count which is smaller than the predetermined value is set as the non-target attribute value 40.

In this way, the threshold value is set for the frequency, and the attribute value smaller than a certain threshold value is set as the non-target attribute value 40. As shown in FIG. 11B, the attribute values except the non-target attribute value 40 are used, and the fitting is performed, with the result that the frequency function f(x) is calculated.

It should be noted that the frequency function may be calculated once, and an attribute value of the first appearance frequency as an output thereof which is smaller than a predetermined value may be calculated as the non-target attribute value 40. Then, on the basis of the attribute values except the non-target attribute value 40, the frequency function may be calculated again.

A threshold value may be set for the attribute value. For example, in an example shown in FIG. 11, such an algorithm that an attribute value of a predetermined height or more is set as the non-target attribute value 40 may be employed.

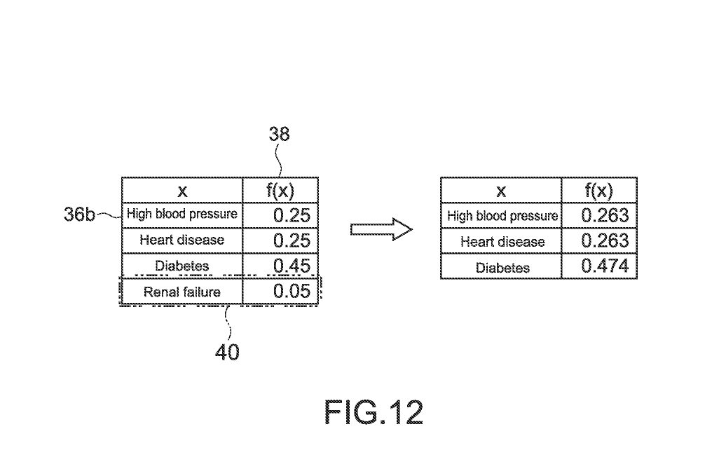

In the case where the database of discrete values having no order as shown in FIG. 7C, the frequency function f(x) in which the ratios 38 of the appearance counts for each attribute value 36b are as the first appearance frequency is calculated as shown in FIG. 10. In such a case that the values have no order, as shown in FIG. 12, for example, the frequency function f(x) is calculated once, and then the attribute value of a small frequency (ratio 38 of the appearance count) may be set as the non-target attribute value 40. In the example shown in FIG. 12, an attribute value of “renal failure” is set as the non-target attribute value 40. Then, the frequency function f(x) is calculated again on the basis of the attribute values except the non-target attribute value 40.

It should be noted that even in the case where the frequency function has a plurality of variables, it is possible to appropriately set the non-target attribute value on the basis of a frequency and the like in combination of those.

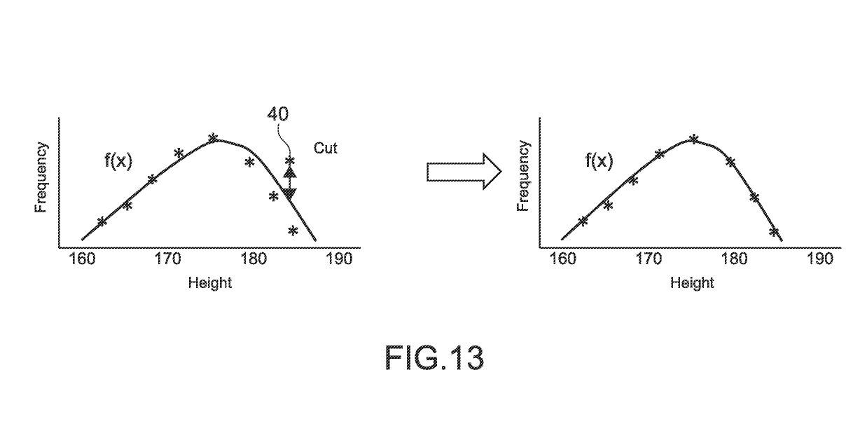

With reference to FIG. 13, another method of setting the non-target attribute value 40 will be described. This method is also used in the case where a model function is subjected to fitting to calculate the frequency function, the case where a frequency function is estimated by using the maximum likelihood estimation method, or the like.

In an example shown in FIG. 13, the frequency function f(x) is calculated by fitting. Such an attribute value that a difference between the first appearance frequency (graph of FIG. 13) expressed by f(x) calculated once and a frequency of the attribute value x is larger than a predetermined value is set as the non-target attribute value 40.

In the case where the frequency function is calculated on the basis of the ratios of the appearance counts for each attribute value, such an attribute value that a difference between the ratio of the appearance count and the first appearance frequency expressed by the frequency function is larger than a predetermined value is set as the non-target attribute value 40. By setting the threshold value as appropriate, the setting process may be performed.

As shown in FIG. 13, the frequency function relating to the appearance functions of the one or more attribute values except the non-target attribute value 40 is calculated again. Then, the pseudo sample data generation unit generates pseudo sample data from the one or more attribute values except the non-target attribute value 40 on the basis of the frequency function calculated again.

The difference between the first appearance frequency expressed by the frequency function generated once as described above and the frequencies for each attribute value such as the ratio of the appearance count may be calculated. Such an attribute value that the difference is larger than a predetermined value may be set as the non-target attribute value 40.

As described above, in the data providing apparatus as the information processing apparatus according to this embodiment, the non-target attribute value 40 which is not used for the calculation of the frequency function is set. For example, a characteristic attribute value which is not desired to be included in the pseudo sample data is set as the non-target attribute value 40. As a result, it is possible to generate useful sample data. For example, an attribute value of the appearance count which is small or such an attribute value that a difference between the ratio of the appearance count and the first appearance frequency is large is set as the non-target attribute value 40 as the characteristic attribute value.

Data of a person who is very high, data of a person having an uncommon previous disease, and the like are valuable data having important meanings in many cases. If such data leaks as the sample data, there is a possibility that the persons are identified, for example. In this embodiment, by using the frequencies or the like for each attribute value, the non-target attribute value 40 is set so that such a unique value that is outside the entire tendency is excluded. Then, the frequency function is calculated, and the pseudo sample data is generated with the non-target attribute value 40 excluded. As a result, it is possible to prevent the leakage of the valuable information having the important meaning.

In the case where the sample data is generated at a certain ratio, the characteristic attribute value shown in FIG. 11A (referred to as an outlier) (height of ID 2000) may be transmitted to the data user. When the sample ratio is p %, the outlier is selected as the sample data with a probability of p/100. Further, in the case where the sample data is generated by adding a noise to the data, data of 190+ε is generated as the sample data. To increase utility value of the data, it is demanded that ε is small, so the data may leak as the characteristic information in the end.

Further, in the case where there is a possibility that the person whose height is 190 cm or more may be specified, the data may be combined with different data, leading to the leakage of sensitive data (previous disease or the like). In this embodiment, the low appearance frequency, the large gap between the frequency function calculated once and the original data, or the like are user, thereby making it possible to prevent the leakage of the data.

### Third Embodiment

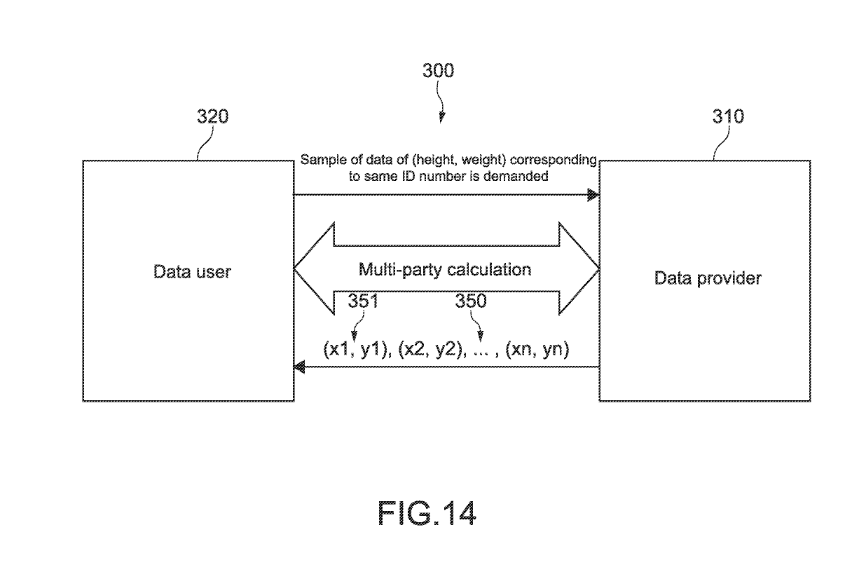

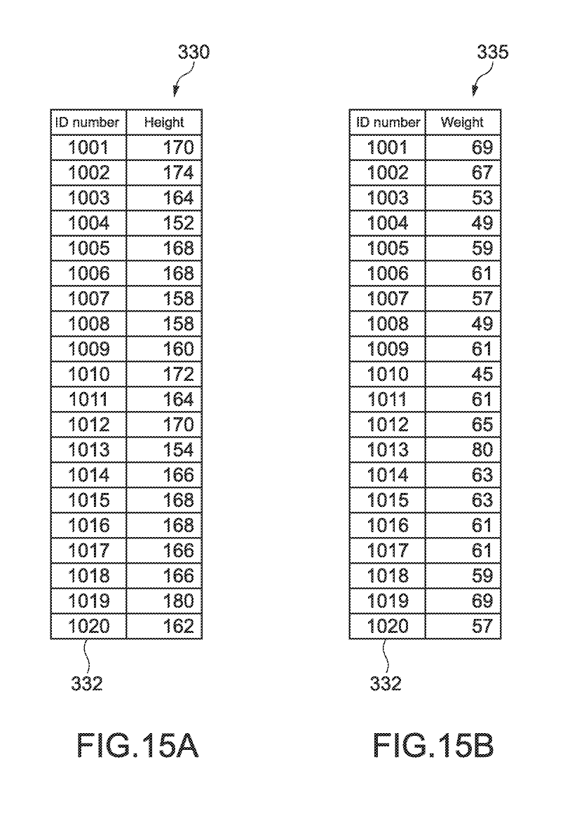

A data providing system according to a third embodiment of the present disclosure will be described. FIG. 14 is a schematic diagram for explaining the outline of an operation of a data providing system 300 according to this embodiment. FIG. 15 is a diagram showing an example of a database held by a data providing apparatus 310 and a data reception apparatus 320 according to this embodiment.

In this embodiment, in a storage unit of the data reception apparatus 320 as an external apparatus, a database as external data is stored. In a storage unit of the data providing apparatus 310, a database relating to the external data is stored. The database relating to the external data corresponds to relevant data. In this situation, the data user operates the data reception apparatus 320 to transmit the external data and a request for pseudo sample data relating the relevant data to the data providing apparatus 310.

In this embodiment, a database indicated by a table 330 as shown in FIG. 15A is stored as the external data. Further, a database indicated by a table 335 as shown in FIG. 15B is stored as the relevant data.

The table 330 shown in FIG. 15A is constituted of fields 332 of “ID numbers” and “heights”. The table 335 shown in FIG. 15B is constituted of the fields 332 of the “ID numbers” and “weights”. In the same “ID numbers”, data of the same persons is stored.

As shown in FIG. 14, in this embodiment, as the external data, the whole of the table 330 or a predetermined part thereof is transmitted to the data providing apparatus 310. As a request for the pseudo sample data relating to the relevant data, a request for pseudo sample data relating to data of a combination of (height, weight) corresponding to the same ID number is transmitted.

A reception unit of the data providing apparatus 310 receives the request for the pseudo sample data and the external data. The frequency function calculation unit generates a frequency function as described in the above embodiments with the combination of the external data and the relevant data, that is, the combination of the (height, weight) corresponding to the same ID number as the one or more attribute values.

On the basis of the frequency function calculated, the pseudo sample data generation unit generates a pseudo sample data 350 including a set of (height, weight) obtained by combining the external data and the relevant data as one or more sample attribute values. The pseudo sample data 350 generated is transmitted to the data reception apparatus 320. Elements of the pseudo sample data ((x1, y1), (x2, y2), . . . (xn, yn)) shown in FIG. 14 represent sample attribute values 351.

Further, in this embodiment, the above-mentioned process is performed by multi-party computation (MPC).

Therefore, various blocks including the frequency function calculation unit, the pseudo sample data generation unit, and the reception unit of the data providing apparatus 310 can be operated on the basis of a multi-party protocol. The MPC refers to a protocol for executing computation in common while concealing data of each other. In this embodiment, in the state in which data of heights and weights is concealed between each other, the frequency function is calculated, and the pseudo sample data is generated.

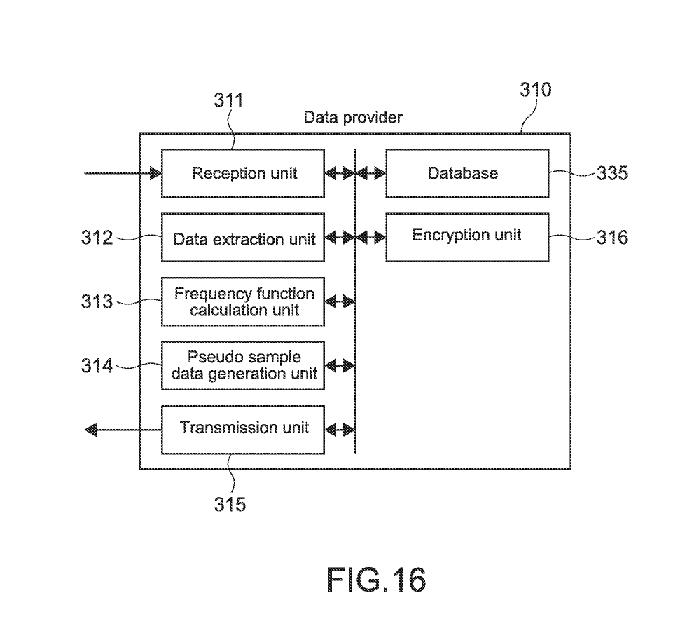

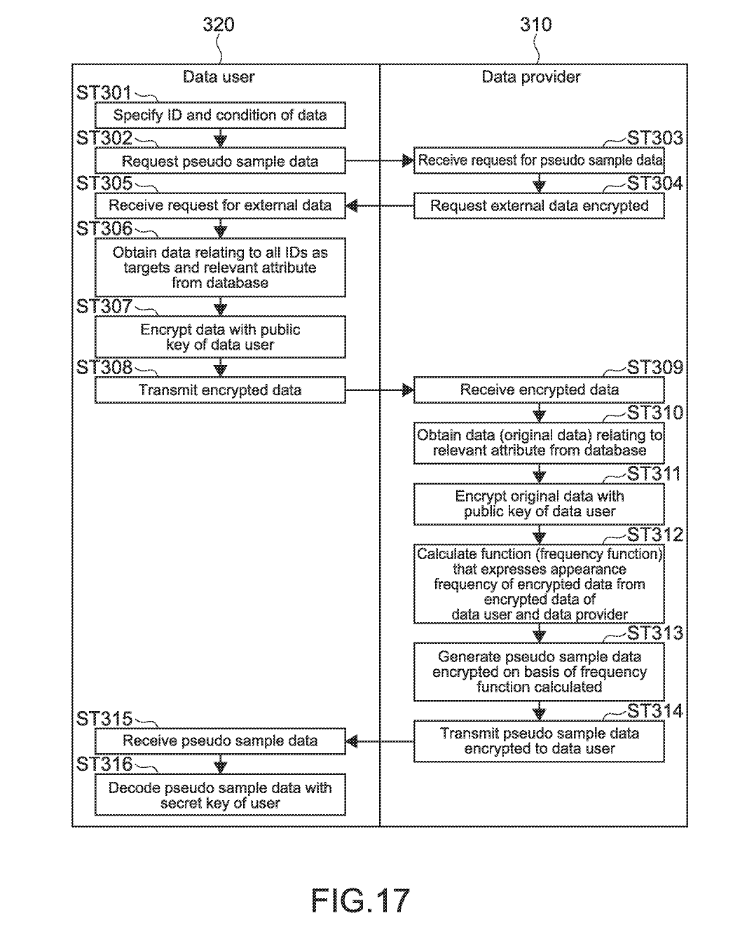

To generate the pseudo sample data 350 by the data providing apparatus 310 will be described in detail. FIG. 16 is a schematic diagram showing an example of a software structure of the data providing apparatus 310. FIG. 17 is a flowchart showing the generation of the pseudo sample data 350 by the data providing apparatus 310.

The data user specifies conditions of data necessary as the pseudo sample data 350 with respect to the data reception apparatus 320. Further, an ID number that demands the pseudo sample data 350 is specified (Step 301). A transmission unit of the data reception apparatus 320 transmits a request for the pseudo sample data 350 based on the specifications to the data providing apparatus 310 (Step 302).

The conditions and ID specifications in Step 301 are as follows, for example.

Condition 4: data of combinations of heights and weights in the tables 330 and 335

Condition 5: data of combinations of heights and weights of IDs whose heights are 170 cm or more in the table 330.

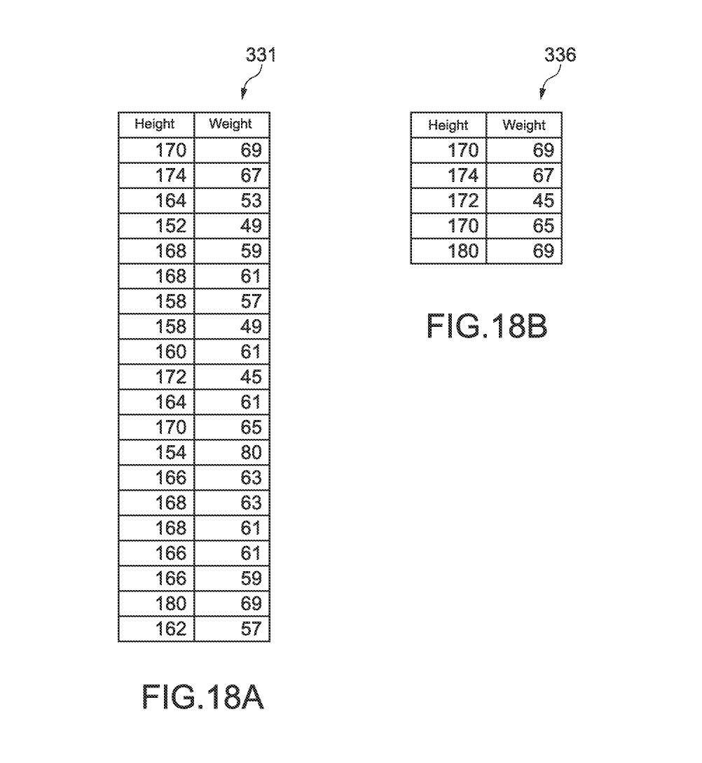

FIGS. 18A and 18B are diagrams each showing a table indicating the data of Conditions 4 and 5. A table 331 shown in FIG. 18A shows the data of the combinations of the heights and the weights in Condition 4. A table 336 shown in FIG. 18B shows the data of the combinations of the heights and the weights of the IDs whose heights are 170 cm or more in Condition 5.

A reception unit 311 of the data providing apparatus 310 receives the request for the pseudo sample data 350 (Step 303). The data providing apparatus 310 transmits, to the data reception apparatus 320, a request for encrypted external data for creating the pseudo sample data 350 (Step 304).

For example, in the case where Condition 4 is specified, encrypted data of the heights in the table 330 (data of the heights in the table 336) is requested. In the case where Condition 5 is specified, encrypted data of the heights of 170 cm or more in the table 335 (data of the heights in the table 336) is requested. The request for the external data is generated by an external data request unit (not shown), for example, and generated by a transmission unit 315.

The reception unit of the data reception apparatus 320 receives the request for the external data encrypted (Step 305). A selection unit of the data reception apparatus 320 obtains a relevant attribute and data (attribute value) relating to all IDs as targets (Step 306). For example, in the case of Condition 4, the data of the heights is selected, and in the case of Condition 5, the data of the heights of 170 cm or more is selected.

An encryption unit of the data reception apparatus 320 encrypts the external data obtained. In this embodiment, the external data is encrypted by fully homomorphic encryption. In this embodiment, the encryption unit has a key storage unit, and in the key storage unit, a public key and a secret key are stored. The public key is used to execute the encryption of the external data (Step 307).

By the fully homomorphic encryption, a sum or product calculation is possible in the encrypted state, and in the case of an algorithm which can be subjected to a logic, it is possible to obtain an output result of the algorithm with an input value concealed. For example, the following expressions are established.

Enc(pk,p1)+Enc(pk,p2)=Enc(pk,p1+p2)

Enc(pk,p1)*Enc(pk,p2)=Enc(pk,p1*p2)

where p1 and p2 are plain texts, and pk is the public key of the data provider.

In this embodiment, the input values p1 and p2 are the external data and the relevant data. The algorithm is the calculation of the frequency function with respect to the data combined and the generation of the pseudo sample data based on the frequency function. That is, an output result is the pseudo sample data.

The transmission unit of the data reception apparatus 320 transmits the encrypted external data to the data providing apparatus 310 (Step 308). The reception unit 311 of the data providing apparatus 310 receives the external data encrypted (Step 309).

A data extraction unit 312 obtains the relevant data (original data) relating to a relevant attribute from the database in the table 335 (Step 310). For example, in the case of Condition 4, the data of the weights in the table 331 shown in FIG. 18A is selected. In the case of Condition 5, the data of the weights in the table 336 shown in FIG. 18B is selected.

An encryption unit 316 encrypts the relevant data selected. In the same way as the encryption of the external data, the relevant data is encrypted by the fully homomorphic encryption. The encryption is performed with the use of the public key of the data reception apparatus 320 (Step 311). The public key may be transmitted to the data providing apparatus 310 along with the external data encrypted. The public key may be stored in the storage unit or the like of the data providing apparatus 310 by another method.

The method of the encryption of the data by the data reception apparatus 320 and the data providing apparatus 310, the structure for the encryption, the algorithm, and the like are not limited.

A frequency function calculation unit 313 calculates a frequency function f(x, y) relating to the combination of the encrypted external data and the encrypted external data (Step 312). That is, by the method described in the above embodiments, the frequency function is calculated with the encrypted combination data of the (heights, weights) combined on the basis of the IDs as attribute values.

On the basis of the frequency function f(x, y) calculated, a pseudo sample data generation unit 314 generates pseudo sample data ((x1, y1), (x2, y2), . . . (xn, yn)) relating to the combination of the encrypted external data and the encrypted relevant data (Step 313). The pseudo sample data 350 is data including the encrypted combination data of (heights, weights) as the sample attribute values 351.

As described in the above embodiment, the pseudo sample data ((x1, y1), (x2, y2), . . . (xn, yn)) is generated so that the first appearance frequency expressed by the frequency function f(x, y) and a second appearance frequency in the pseudo sample data 350 are corresponded to each other.

The transmission unit 315 transmits the generated pseudo sample data ((x1, y1), (x2, y2), . . . (xn, yn)) to the data reception apparatus 320 (Step 314). The data reception apparatus 320 receives the pseudo sample data ((x1, y1), (x2, y2), . . . (xn, yn)) (Step 315).

A decoding unit of the data reception apparatus 320 decodes the pseudo sample data 350, which is the data encrypted. In this embodiment, the secret key stored in the key storage unit of the data reception apparatus 320 is used, thereby decoding the encrypted combination data of (heights, weights) (Step 316).

As described above, in the data providing system 300 according to this embodiment, the request for the pseudo sample data 350 and the external data are transmitted from the data reception apparatus 320. The external data and the request for the pseudo sample data 350 may be transmitted at the same timing or at different timings. Then, for the combination of the external data and the relevant data relating thereto, the pseudo sample data 350 is generated. As a result, it is possible to generate the pseudo sample data 350 for the correlation between the data relevant to each other, for example. It is also possible to have the correlation between data held by a plurality of data providers, for example. As a result, it is possible to attain the data providing system 300 useful for the data provider and the data user.

In this embodiment, by the multi-party computation, the pseudo sample data 350 relating to the combination of the external data and the relevant data is generated. That is, the frequency function is calculated by the fitting or the maximum likelihood estimation method with the encrypted combination data as the attribute value. On the basis of the frequency function, the pseudo sample data 350 is generated. As a result, it is possible to generate, provide, and receive the pseudo sample data 350 with the data concealed with respect to each other. Consequently, it is possible to attain the useful data providing system 300.

It should be noted that, to an apparatus different from the data providing apparatus 310 and the data reception apparatus 320, the external data and the relevant data may be transmitted, and in the different apparatus, the pseudo sample data 350 may be generated by the multi-party computation.

### Fourth Embodiment

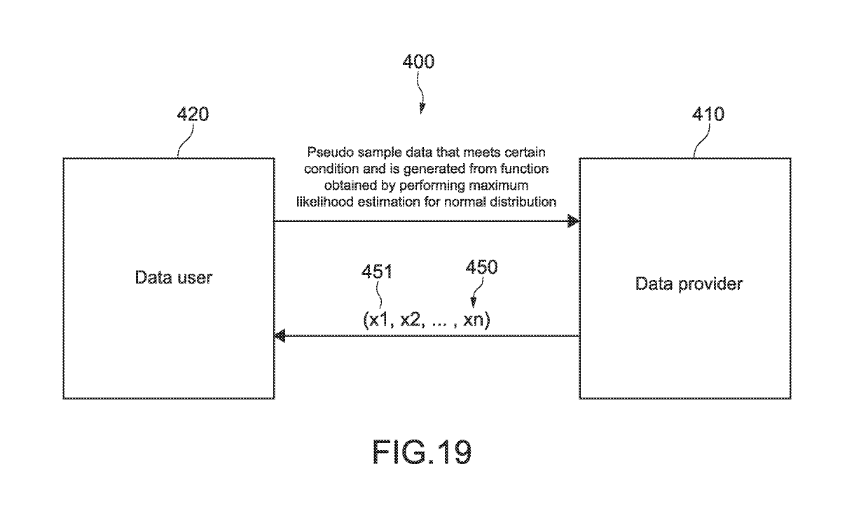

A data providing system according to a fourth embodiment of the present disclosure will be described. FIG. 19 is a schematic diagram for explaining the outline of an operation of a data providing system 400 according to this embodiment.

In this embodiment, as a function relating to appearance frequencies of one or more attribute values, a data providing apparatus 410 can generate the first frequency function and the second frequency function different from the first frequency function. That is, as the frequency function, it is possible to generate at least two different functions.

A data reception apparatus 420 transmits a specification for selecting one of the first and second frequency functions. The specification is received by a reception unit of the data providing apparatus 410. Therefore, it is possible for the data provider to select the frequency function and specify a method of generating the pseudo sample data. The specification of the selection of the frequency function may be received at an arbitrary timing.

As described in the above embodiments, as the calculation method for the frequency functions and the method of generating the pseudo sample data, the following various options are conceivable.

Kinds of the generation methods for the frequency functions (a method of performing fitting for a model function, a method of estimating a probability function by using the maximum likelihood estimation method, or the like)

Kinds of model functions used for the fitting (exponential function, linear function, logarithmetic function, polynomial function, gauss function, or the like

Kinds of probability models used for the maximum likelihood estimation method (Gaussian distribution, binomial distribution, Poisson distribution, or the like)

Presence or absence of setting of the non-target attribute value (outlier)

Content of a method of setting the non-target attribute value (degree of a threshold value for setting the non-target attribute value or the like)

The number of attribute values used for the calculation of the frequency function

The number of sample attribute values included in the pseudo sample data

Convergence condition of algorithm (repetition count or the like in least-squares, for example)

In addition, there are various examples of the method of calculating the frequency function. Out of those, at least two frequency functions are generated, and those are calculated as the first and second frequency functions. Two or more frequency functions can be generated. Further, the pseudo sample data generation unit may perform a plurality of methods of generating the pseudo sample data on the basis of the frequency functions. On the basis of an instruction of the generation method from the data user, the pseudo sample data may be generated as appropriate.

As shown in FIG. 19, the data reception apparatus 420 transmits a request for sample data of data that satisfies a certain condition and a specification of the frequency function. Here, a request for the pseudo sample data generated from the frequency function obtained by performing the maximum likelihood estimation of a normal distribution is transmitted. The data providing apparatus 410 transmits, to the data reception apparatus 420, pseudo sample data 450 generated on the basis of the frequency function instructed. Elements of the pseudo sample data (x1, x2, . . . xn) shown in FIG. 19 represents sample attribute values 451.

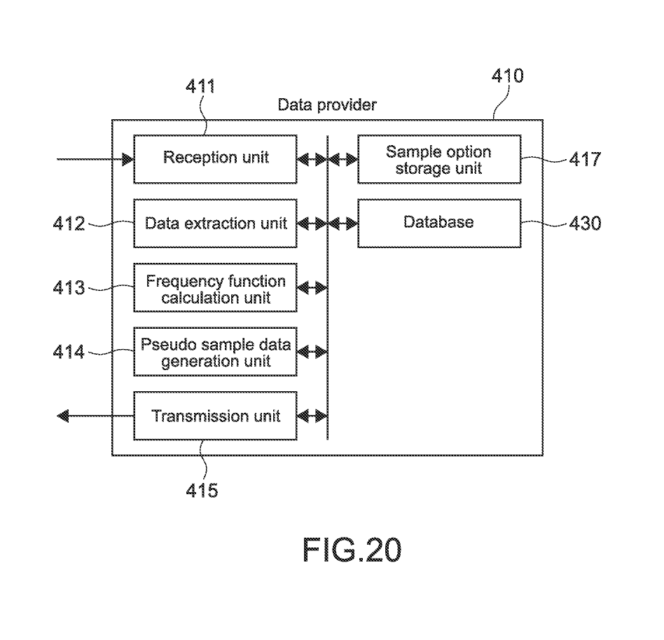

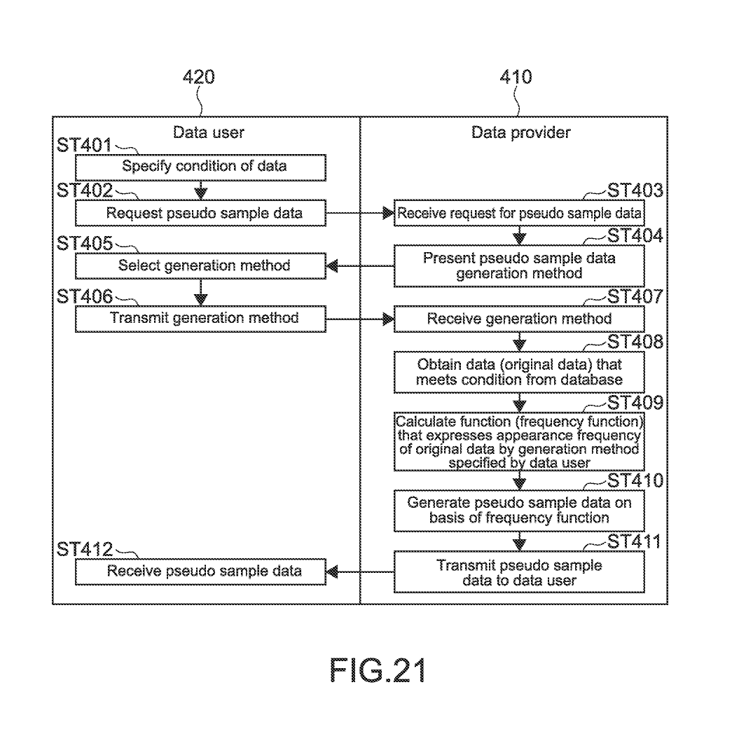

FIG. 20 is a schematic diagram showing an example of a software structure of the data providing apparatus 410. FIG. 21 is a flowchart showing the generation of the pseudo sample data 450 by the data providing apparatus 410.

A condition of data necessary as the pseudo sample data 450 is specified, and a request for the pseudo sample data 450 is transmitted (Steps 401 and 402). A reception unit 411 receives the request for the pseudo sample data 450 (Step 403).

Information for presenting a method of generating the pseudo sample data which can be executed by the data providing apparatus 410 is transmitted to the data reception apparatus 420 (Step 404). The information relating to the method of generating the pseudo sample data executable is stored in a sample option storage unit 417 shown in FIG. 20. The information that is presented to the data reception apparatus 420 includes information relating to the first and second frequency functions.

On the basis of the information presented, the data reception apparatus 420 selects the method of generating the pseudo sample data 450 and transmits an instruction of the generation method to the data providing apparatus 410 (Steps 405 and 406). The instruction includes a specification for selecting one of the first and second frequency functions.

The reception unit 411 receives the instruction of the method of generating the pseudo sample data 450 (Step 407). A data extraction unit 412 selects original data from a database 430 (Step 408). A frequency function calculation unit 413 calculates the frequency function by the method of generating the pseudo sample data specified by the data user. That is, on the basis of the instruction from the data reception apparatus 420, one of the first and second frequency functions is calculated (Step 409).

A pseudo sample data generation unit 414 generates the pseudo sample data 450 on the basis of the frequency function calculated, and a transmission unit 415 transmits the pseudo sample data 450 to the data reception apparatus 420 (Steps 410 and 411). The data reception apparatus 420 receives the pseudo sample data 450 (Step 412).

As described above, in the data providing system 400 according to this embodiment, it is possible for the data providing apparatus 410 to generate the two different frequency functions. On the basis of the specification from the external apparatus, one of the first and second frequency functions is selected as appropriate. As a result, it is possible to attain the useful data providing system 400.

In this embodiment, the plurality of frequency functions can be generated on the data providing side, and a plurality of generation methods for the pseudo sample data can be used. Therefore, it is possible for the data provider to appropriately select one from the plurality of generation methods and obtain desired pseudo sample data 450.

For example, depending on the method of generating the frequency function, the number of attribute values used therefor, or the like, the statistical accuracy of the pseudo sample data 450 varies. Therefore, by using the different generation method as appropriate, the data user can control the accuracy of the pseudo sample data 450 to be given to the data user. Thus, it is possible to set a price in accordance with the accuracy by the data provider and generate diversity of service. On the other hand, it is also possible for the data user to obtain the pseudo sample data 450 in accordance with an ultimate intent of analysis, for example. That is, relating to the pseudo sample data 450 desired, a lot of choices are provided. As a result, the data providing system 400 useful for the data provider and the data user is attained.

In this embodiment, in response to the request for the pseudo sample data 450, the method of generating the pseudo sample data executable by the data providing apparatus 410 is presented. In addition to this, the method of generating the pseudo sample data 450 executable may be presented to an external apparatus in advance.

### Fifth Embodiment

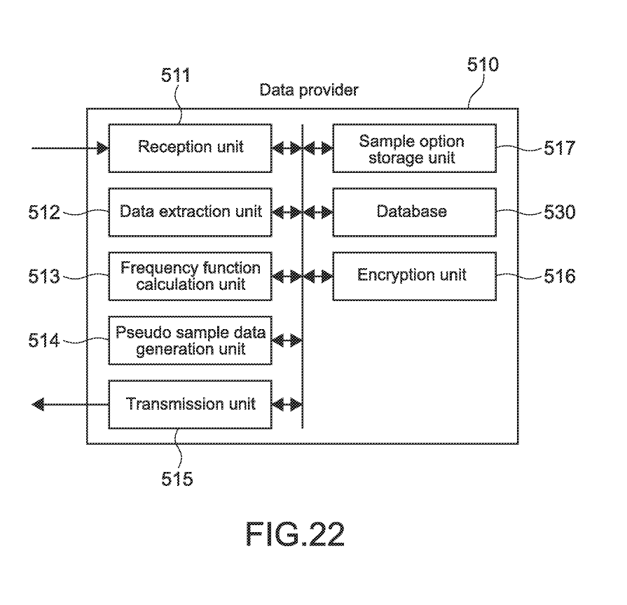

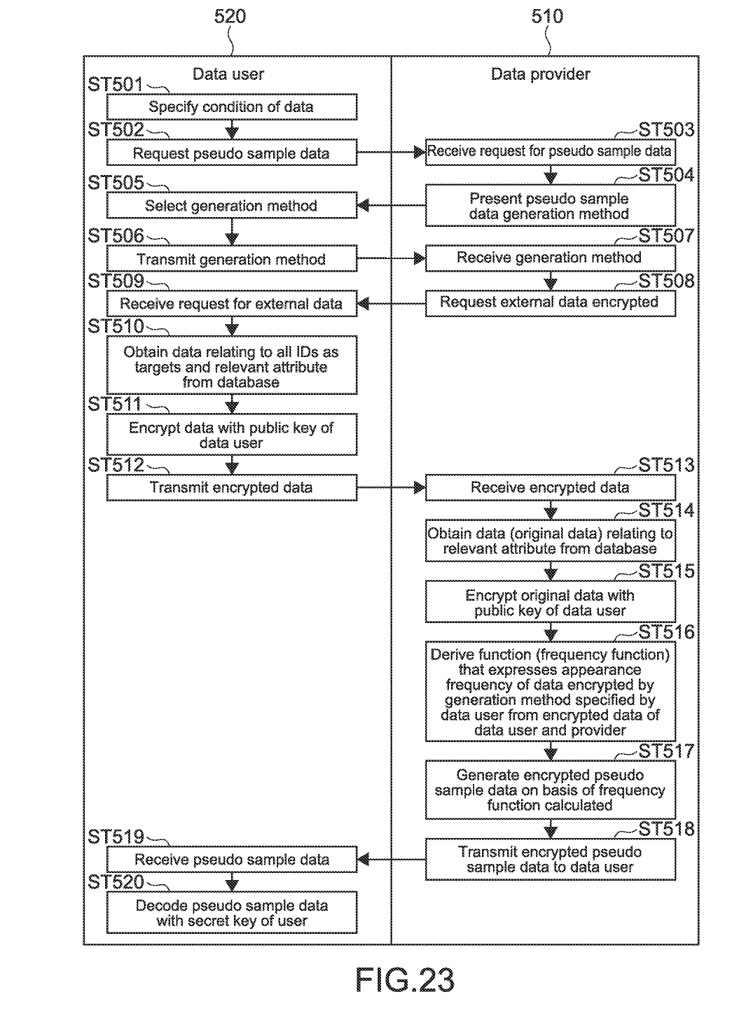

A data providing system according to a fifth embodiment of the present disclosure will be described. FIG. 22 is a schematic diagram showing an example of a software structure of a data providing apparatus 510. FIG. 23 is a flowchart showing the generation of pseudo sample data by the data providing apparatus 510.

In this embodiment, on the basis of the multi-party computation described above, pseudo sample data relating to a combination of external data of a data reception apparatus 520 and relevant data of the data providing apparatus 510 is generated. Further, in this embodiment, as described above, the data providing apparatus 510 can generate a plurality of frequency functions, and a plurality of methods of generating the pseudo sample data can be used.

In this embodiment, in response to a request for the pseudo sample data, information relating to the method of generating the pseudo sample data executable, which is stored in a sample option storage unit 517, transmitted to the data reception apparatus 520 (Steps 501 to 504). The data reception apparatus 520 specifies the method of generating the pseudo sample data, and the specification is transmitted to the data providing apparatus 510 (Steps 505 and 506).

In accordance with the specification of the method of generating the pseudo sample data, the data providing apparatus 510 transmits a request for encrypted external data to the data reception apparatus 520 (Steps 507 and 508). The data reception apparatus 520 encrypts the external data and transmits the encrypted external data to the data providing apparatus 510 (Steps 509 to 512).

The data providing apparatus 510 selects relevant data relating to the external data and encrypts the data (Steps 513 to 515). Then, on the basis of the method of generating the pseudo sample data specified by the data user, the frequency function is calculated, and the pseudo sample data relating to a combination of the external data encrypted on the basis of the frequency function and the relevant data is generated (Steps 516 and 517). The pseudo sample data generated is transmitted to the data reception apparatus 520 and decoded by the data reception apparatus 520 (Steps 518 to 520).

As in this embodiment, in the generation of the pseudo sample data relating to the combination of the external data and the relevant data, the data user can select the method of generating the pseudo sample data. As a result, the data providing system useful for the data provider and the data user is attained.

### Modified Example

The present disclosure is not limited to the above embodiments and is variously modified.

For example, in the calculation of the ratios of the appearance counts for each attribute value as shown in FIG. 8, granularity of the attribute values may be adjusted as appropriate. That is, for example, in the case where the ratios of the appearance counts for each attribute value, a plurality of attribute values may be combined to calculate the ratio of the appearance count. For example, in FIG. 8, a plurality of pieces of data of the heights are combined, and a ratio of an appearance count of 150 to 154 may be calculated. A value calculated by the combination is the ratio of the appearance count for each of the plurality of attribute values.

In addition to the database exemplified in the above embodiments, the present disclosure is applicable to providing various databases. For example, to provide a database relating to weather information, traffic information, medical information, or the like, the data providing system according to the present disclosure may be used. Further, the present disclosure may be applied to not the relational database but an object database.

In the generation of the pseudo sample data by the multi-party computation described above, the multi-party protocol to be used is not limited, and any protocol may be used.

Out of the characteristic parts of the embodiments described above, at least two characteristic parts can be combined.

It should be noted that the present disclosure can take the following configurations.

(1) An information processing apparatus, including:

a calculation unit configured to calculate a frequency function which is a function relating to an appearance frequency of one or more attribute values of a database having a predetermined attribute and the one or more attribute values relating to the attribute; and

a generation unit configured to generate sample data in accordance with the appearance frequency relating to the database on the basis of the frequency function calculated, the sample data including at least a part of the one or more attribute values as one or more sample attribute values.

(2) The information processing apparatus according to Item (1), in which

the frequency function expresses a first appearance frequency, which is an appearance frequency for each attribute value.

(3) The information processing apparatus according to Item (2), in which

the generation unit generates the sample data so that the first appearance frequency for each sample attribute value expressed by the frequency function and a second appearance frequency, which is an appearance frequency for each sample attribute value in the sample data are corresponded to each other.

(4) The information processing apparatus according to Item (2) or (3), in which

the calculation unit calculates a ratio of an appearance count of the one or more attribute values to a total count for each attribute value and calculates the frequency function that expresses an approximation value obtained by approximating the ratio of the appearance count as the first appearance frequency.

(5) The information processing apparatus according to Item (4), in which

the calculation unit selects a predetermined model function and fits the predetermined model function to the ratio of the appearance count for each attribute value to calculate the frequency function.

(6) The information processing apparatus according to Item (4) or (5), in which

the calculation unit estimates a probability function in accordance with the ratio of the appearance count for each attribute value by a maximum likelihood estimation method to calculate the estimated probability function as the frequency function.

(7) The information processing apparatus according to any one of Items (2) to (6), in which

the calculation unit calculates a ratio of an appearance count of the one or more attribute values to a total count for each attribute value and generates the frequency function that expresses the ratio of the appearance count as the first appearance frequency.

(8) The information processing apparatus according to any one of Items (1) to (7), further including

a setting unit configured to set a predetermined attribute value out of the one or more attribute values as a non-target attribute value that is out of use for the calculation of the frequency function by the calculation unit, in which

the calculation unit calculates the frequency function relating to the appearance frequency of the one or more attribute values except the non-target attribute value set, and

the generation unit generates the sample data from the one or more attribute values except the non-target attribute value on the basis of the frequency function calculated.

(9) The information processing apparatus according to Item (8), in which

the calculation unit calculates a ratio of an appearance count of the one or more attribute values to a total count for each attribute value and generates the frequency function on the basis of the ratio of the appearance count, and

the setting unit sets an attribute value whose ratio of the appearance count is smaller than a predetermined value as the non-target attribute value on the basis of the ratio of the appearance count for each attribute value.

(10) The information processing apparatus according to Item (8), in which

the calculation unit calculates a ratio of an appearance count of the one or more attribute values to a total count for each attribute value and generates the frequency function on the basis of the ratio of the appearance count,

the setting unit sets, as the non-target attribute value, an attribute value having a larger difference between the ratio of the appearance count and the first appearance frequency expressed by the frequency function than a predetermined value on the basis of the ratio of the appearance count for each attribute value,

the calculation unit calculates again the frequency function relating to the appearance frequency of the one or more attribute values except the non-target attribute value set, and

the generation unit generates the sample data from the one or more attribute values except the non-target attribute value on the basis of the frequency function calculated again.

(11) The information processing apparatus according to any one of Items (1) to (10), further including:

a reception unit configured to receive a request for the sample data relating to predetermined data in the database; and

a selection unit configured to select the predetermined data from the database on the basis of the request, in which

the calculation unit calculates the frequency function in relation to the predetermined data selected, and

the generation unit generates the sample data from the predetermined data on the basis of the frequency function calculated.

(12) The information processing apparatus according to Item (11), in which

the reception unit receives external data held by an external apparatus and a request for the sample data relating to relevant data relevant to the external data in the database;

the calculation unit calculates the frequency function with a combination of the external data and the relevant data as the one or more attribute values; and

the generation unit generates the sample data including the combination of the external data and the relevant data as the one or more sample attribute values on the basis of the frequency function calculated.

(13) The information processing apparatus according to Item (12), in which

the reception unit, the calculation unit, and the generation unit are capable of being operated on the basis of a multi-party protocol.

(14) The information processing apparatus according to Item (13), in which

the reception unit receives the external data encrypted by fully homomorphic encryption,

the information processing apparatus further including

an encryption unit configured to encrypt the relevant data by the fully homomorphic encryption, in which

the calculation unit calculates the frequency function in relation to a combination of the external data encrypted and the relevant data encrypted, and

the generation unit generates, on the basis of the frequency function calculated, the sample data relating to the combination of the external data encrypted and the relevant data encrypted.

(15) The information processing apparatus according to any one of Items (11) to (14), in which

the calculation unit is capable of generating, as functions relating to the appearance frequency of the one or more attribute values, a first frequency function and a second frequency function different from the first frequency function, and

the reception unit receives a specification for selecting one of the first frequency function and the second frequency function from the external apparatus.

The present disclosure contains subject matter related to that disclosed in Japanese Priority Patent Application JP 2012-150237 filed in the Japan Patent Office on Jul. 4, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a calculation unit configured to calculate a frequency function which is a function relating to an appearance frequency of one or more attribute values of a database having a predetermined attribute and the one or more attribute values relating to the attribute; and
a generation unit configured to generate sample data in accordance with the appearance frequency relating to the database on the basis of the frequency function calculated, the sample data including at least a part of the one or more attribute values as one or more sample attribute values.

2. The information processing apparatus according to claim 1, wherein
the frequency function expresses a first appearance frequency, which is an appearance frequency for each attribute value.

3. The information processing apparatus according to claim 2, wherein
the generation unit generates the sample data so that the first appearance frequency for each sample attribute value expressed by the frequency function and a second appearance frequency, which is an appearance frequency for each sample attribute value in the sample data, are corresponded to each other.

4. The information processing apparatus according to claim 2, wherein
the calculation unit calculates a ratio of an appearance count of the one or more attribute values to a total count for each attribute value and calculates the frequency function that expresses an approximation value obtained by approximating the ratio of the appearance count as the first appearance frequency.

5. The information processing apparatus according to claim 4, wherein
the calculation unit selects a predetermined model function and fits the predetermined model function to the ratio of the appearance count for each attribute value to calculate the frequency function.

6. The information processing apparatus according to claim 4, wherein
the calculation unit estimates a probability function in accordance with the ratio of the appearance count for each attribute value by a maximum likelihood estimation method to calculate the estimated probability function as the frequency function.

7. The information processing apparatus according to claim 2, wherein
the calculation unit calculates a ratio of an appearance count of the one or more attribute values to a total count for each attribute value and generates the frequency function that expresses the ratio of the appearance count as the first appearance frequency.

8. The information processing apparatus according to claim 1, further comprising
a setting unit configured to set a predetermined attribute value out of the one or more attribute values as a non-target attribute value that is out of use for the calculation of the frequency function by the calculation unit, wherein
the calculation unit calculates the frequency function relating to the appearance frequency of the one or more attribute values except the non-target attribute value set, and
the generation unit generates the sample data from the one or more attribute values except the non-target attribute value on the basis of the frequency function calculated.

9. The information processing apparatus according to claim 8, wherein
the calculation unit calculates a ratio of an appearance count of the one or more attribute values to a total count for each attribute value and generates the frequency function on the basis of the ratio of the appearance count, and
the setting unit sets an attribute value whose ratio of the appearance count is smaller than a predetermined value as the non-target attribute value on the basis of the ratio of the appearance count for each attribute value.

10. The information processing apparatus according to claim 8, wherein
the calculation unit calculates a ratio of an appearance count of the one or more attribute values to a total count for each attribute value and generates the frequency function on the basis of the ratio of the appearance count,
the setting unit sets, as the non-target attribute value, an attribute value having a larger difference between the ratio of the appearance count and the first appearance frequency expressed by the frequency function than a predetermined value on the basis of the ratio of the appearance count for each attribute value,
the calculation unit calculates again the frequency function relating to the appearance frequency of the one or more attribute values except the non-target attribute value set, and
the generation unit generates the sample data from the one or more attribute values except the non-target attribute value on the basis of the frequency function calculated again.

11. The information processing apparatus according to claim 1, further comprising:
a reception unit configured to receive a request for the sample data relating to predetermined data in the database; and
a selection unit configured to select the predetermined data from the database on the basis of the request, wherein
the calculation unit calculates the frequency function in relation to the predetermined data selected, and
the generation unit generates the sample data from the predetermined data on the basis of the frequency function calculated.

12. The information processing apparatus according to claim 11, wherein
the reception unit receives external data held by an external apparatus and a request for the sample data relating to relevant data relevant to the external data in the database;
the calculation unit calculates the frequency function with a combination of the external data and the relevant data as the one or more attribute values; and
the generation unit generates the sample data including the combination of the external data and the relevant data as the one or more sample attribute values on the basis of the frequency function calculated.

13. The information processing apparatus according to claim 12, wherein
the reception unit, the calculation unit, and the generation unit are capable of being operated on the basis of a multi-party protocol.

14. The information processing apparatus according to claim 13, wherein
the reception unit receives the external data encrypted by fully homomorphic encryption,
the information processing apparatus further comprising
an encryption unit configured to encrypt the relevant data by the fully homomorphic encryption, wherein
the calculation unit calculates the frequency function in relation to a combination of the external data encrypted and the relevant data encrypted, and
the generation unit generates, on the basis of the frequency function calculated, the sample data relating to the combination of the external data encrypted and the relevant data encrypted.

15. The information processing apparatus according to claim 11, wherein
the calculation unit is capable of generating, as functions relating to the appearance frequency of the one or more attribute values, a first frequency function and a second frequency function different from the first frequency function, and
the reception unit receives a specification for selecting one of the first frequency function and the second frequency function from the external apparatus.

16. An information processing method, comprising:
calculating a frequency function which is a function relating to an appearance frequency of one or more attribute values of a database having a predetermined attribute and the one or more attribute values relating to the attribute; and
generating sample data in accordance with the appearance frequency relating to the database on the basis of the frequency function calculated, the sample data including at least a part of the one or more attribute values as one or more sample attribute values.

17. A program causing a computer to execute the steps of
calculating a frequency function which is a function relating to an appearance frequency of one or more attribute values of a database having a predetermined attribute and the one or more attribute values relating to the attribute, and
generating sample data in accordance with the appearance frequency relating to the database on the basis of the frequency function calculated, the sample data including at least a part of the one or more attribute values as one or more sample attribute values.

18. An information processing system comprising:
a first information processing apparatus capable of providing a database having a predetermined attribute and one or more attribute values relating to the attribute; and
a second information processing apparatus configured to transmit a request for sample data relating to the database to the first information processing apparatus, wherein
the first information processing apparatus includes
a reception unit configured to receive the request for the sample data from the second information processing apparatus,
a calculation unit configured to calculate a frequency function, which is a function relating to an appearance frequency of the one or more attribute values of the database, and
a generation unit configured to generate the sample data in accordance with the appearance frequency relating to the database on the basis of the frequency function calculated, the sample data including at least a part of the one or more attribute values as one or more sample attribute values, and
the second information processing apparatus includes
a transmission unit configured to transmit a request for the sample data, and
a reception unit configured to receive the sample data generated.

19. An information processing apparatus, comprising:
a transmission unit configured to transmit a request for sample data relating to a database having a predetermined attribute and one or more attribute values relating to the attribute to a data providing apparatus capable of providing the database; and
a reception unit configured to receive the sample data in accordance with an appearance frequency of the one or more attribute values, the sample data being generated on the basis of a frequency function as a function relating to the appearance frequency by the data providing apparatus that receives the request and including at least a part of the one or more attribute values as one or more sample attribute values.
